(19) United States
(12) Patent Application Publication
(10) Pub. No.: US 2012/0116828 A1
(43) Pub. Date: May 10, 2012

(54) PROMOTIONS AND ADVERTISING SYSTEM

(76) Inventor: Jeffrey L. Shannon, Bayfield, WI (US)

(21) Appl. No.: 13/104,622

(22) Filed: May 10, 2011

Related U.S. Application Data
(60) Provisional application No. 61/333,095, filed on May 10, 2010.

(51) Int. Cl. G06Q 30/02; G06Q 10/06

(52) U.S. Cl. 705/7.12; 705/14.35

(57) ABSTRACT

A system for promoting a business includes a business interface module and a consumer interface module. The business interface module receives information from businesses identifying information to be conveyed to consumers, such as special offers available from the businesses. The consumer interface module conveys the information to the consumers.

### CROSS-REFERENCE TO RELATED APPLICATION

This application claims priority to U.S. Ser. No. 61/333,095 titled PROMOTIONS AND ADVERTISING SYSTEM, filed on May 10, 2010, the disclosure of which is hereby incorporated by reference in its entirety.

### BACKGROUND

There are a variety of techniques that are used by businesses to promote their goods or services. The techniques range from advertising in printed publications, such as magazines and newspapers, to online advertising through custom-designed web sites.

Many businesses have their own web sites for this purpose, but these web sites often suffer from various limitations. A custom-designed web site can be expensive to develop, and can require significant resources to maintain over time. Also, because the web site typically contains only information about a single business, the web site will typically not draw a large amount of traffic, and therefore has only a limited audience at any given time.

There is a need for improved techniques for promoting and advertising businesses goods or services.

### SUMMARY

In general terms, this disclosure is directed to a promotion and advertising system. In one possible configuration and by non-limiting example, the system is provided with information about special offers from multiple businesses. The system conveys this information to consumers to inform consumers of the special offers and to encourage consumers to purchase the goods or services of the businesses.

One aspect is a method of communicating restaurant special offers to consumers, the method comprising: providing from a server computing device a web-based business interface to be displayed to business representatives associated with multiple restaurants; receiving from the business representatives business information associated with the restaurants through the web-based business interface, the information including at least names of the restaurants and locations of the restaurants; receiving from the business representatives information about nonredeemable special offers available from the restaurants, the information including at least a description of the special offer, a start date associated with the special offer, and an end date associated with the special offer; storing the information associated with the restaurants as business data in a data store; storing information about nonredeemable special offers available from the restaurants in specials data in a data store; providing a web-based consumer interface to be displayed to a consumer; receiving a search query from the consumer through the consumer interface, the search query including an identification of a category; automatically identifying a location of the consumer; determining a current date; performing a search of the business data in the data store to identify search results including a set of restaurants that match the identified category, which are at the location, and which have at least one special offer in which the current date is between or equal to one of the start date and the end date; and providing at least some of the search results to the consumer through the consumer interface, including at least one of the descriptions of the special offers.

Another aspect is a system for promoting business specials. The system comprises programmable electronics including at least one processor and at least one computer readable storage medium. The at least one computer readable storage medium contains instructions, which when executed by the at least one processor, cause the at least one processor to generate: a business interface module that receives data describing special offers that are available for limited times from multiple different businesses; a data store storing the data describing the special offers in the at least one computer readable storage medium, and further storing data for each of the multiple different businesses including at least names of the businesses and locations of the businesses; a search module operable to perform a search of the data stored in the data store based on a search query and operable to identify a set of businesses that match the query; and a consumer interface module configured to receive input from a consumer defining the search query to be searched by the search module and to convey at least some of the set of businesses identified by the search module for display to the consumer.

Yet another aspect is a method of promoting a business. The method includes receiving at a computing device business information from business representatives of a plurality of businesses, the business information including at least names of the businesses and locations of the businesses; receiving subscription fees from the businesses; receiving with a computing device information to be communicated to consumers, the information originating from one of the business representatives of one of the businesses; identifying a location of a consumer; identifying a set of the businesses within a range of the consumer, the set of businesses including at least the one of the businesses; and sending the information to be communicated to the consumer.

### BRIEF DESCRIPTION OF THE DRAWINGS

FIG. 1 is a schematic block diagram of an example system for promoting businesses and including a business promotion system.

FIG. 2 is a schematic block diagram illustrating an example architecture of a computing device that can be used to implement aspects of the business promotion system shown in FIG. 1.

FIG. 3 is a schematic block diagram of the business promotion system shown in FIG. 1, including a business interface module and a consumer interface module.

FIG. 4 is a screen shot of an example user interface display of the business interface module shown in FIG. 3.

FIG. 5 is a screen shot of an example new business registration page of the business interface module shown in FIG. 3.

FIG. 6 is a screen shot of an example subscription display of the business interface module shown in FIG. 3.

FIG. 7 is a screen shot of an example main menu display of the business interface module shown in FIG. 3.

FIG. 8 is a screen shot of an example recipe display of the business interface module shown in FIG. 3.

FIG. 9 is a screen shot of an example training materials display of the business interface module shown in FIG. 3.

FIG. 10 is a screen shot of an example cleaning instructions display of the business interface module shown in FIG. 3.

FIG. 11 is a screen shot of an example assigned cleaning display of the business interface module shown in FIG. 3.

FIG. 12 is a screen shot of an example advertisement generator display of the business interface module shown in FIG. 3.

FIG. 13 is a schematic block diagram of an example data store.

FIG. 14 is a schematic block diagram of data stored within the data store shown in FIG. 13.

FIG. 15 is a screen shot of an example main menu display of the consumer interface module shown in FIG. 3.

FIG. 16 is a screen shot of an example categorical business listing display of the consumer interface module shown in FIG. 3.

FIG. 17 is a schematic block diagram illustrating exemplary user interface displays of the consumer interface module shown in FIG. 3.

FIG. 18 is a screen shot of an example search display of the consumer interface module shown in FIG. 3.

FIG. 19 is a screen shot of an example search results display of the consumer interface module shown in FIG. 3.

FIG. 20 is a screen shot of an example business details display of the consumer interface module shown in FIG. 3

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

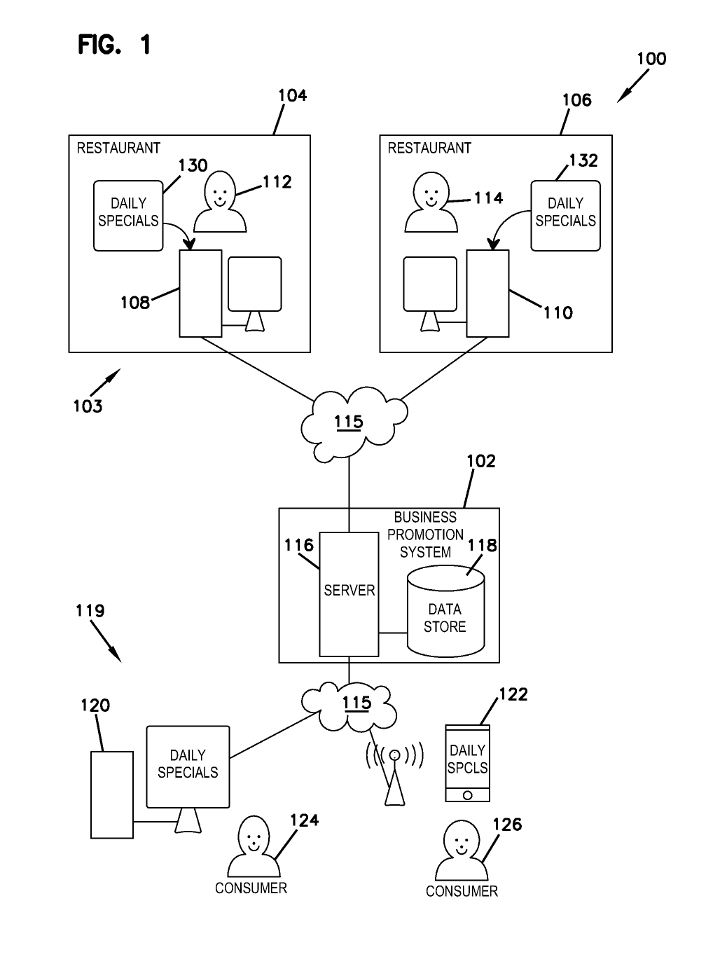

FIG. 1 is a schematic block diagram of an example system 100 for promoting businesses 113. The system 100 includes business promotion system 102, businesses 103 such as restaurants 104 and 106, business computing devices 108 and 110, business representatives 112 and 114, server 116, data store 118, consumer computing devices 120 and 122, and consumers 119 including consumer 124 and consumer 126.

The system 100 cooperates to communicate information from the businesses 103 to the consumers 119. As an example, restaurants 104 and 106 have information that consumers 124 and 126 would like to know. In some embodiments, the information describes special offers provided by the businesses 103, such as daily specials 130 and 132. The information can be input into business computing devices 108 and 110 by business representatives 112 and 114.

The information is then transferred from business computing devices 108 and 110 to business promotion system 102, across a data communication network 115. An example of network 115 is the Internet, but may also include additional networks, such as a local area network, cellular telephone network, wireless communication network, or any other technology suitable for communicating digital data between computing devices.

The business promotion system 102 includes, for example, a server 116 and a data store 118. The information from the businesses 103, such as restaurants 104 and 106, is received by the business promotion system 102 and stored in data store 118.

Consumers 119, including consumers 124 and 126 can then receive the information at consumer computing devices 120 and 122 through network 115. In one example, consumer computing device 120 is a desktop computer, and consumer computing device 122 is a mobile computing device, such as a smart phone.

For example, consumer 124 executes a browser software application on computing device 120, and types in a URL or clicks on a shortcut to a web page associated with the business promotion system 102. The consumer 124 can then browse, search, or otherwise view the information stored in data store 118 that has been provided by the businesses. In this example, the consumer views the daily specials available at restaurants 104 and 106.

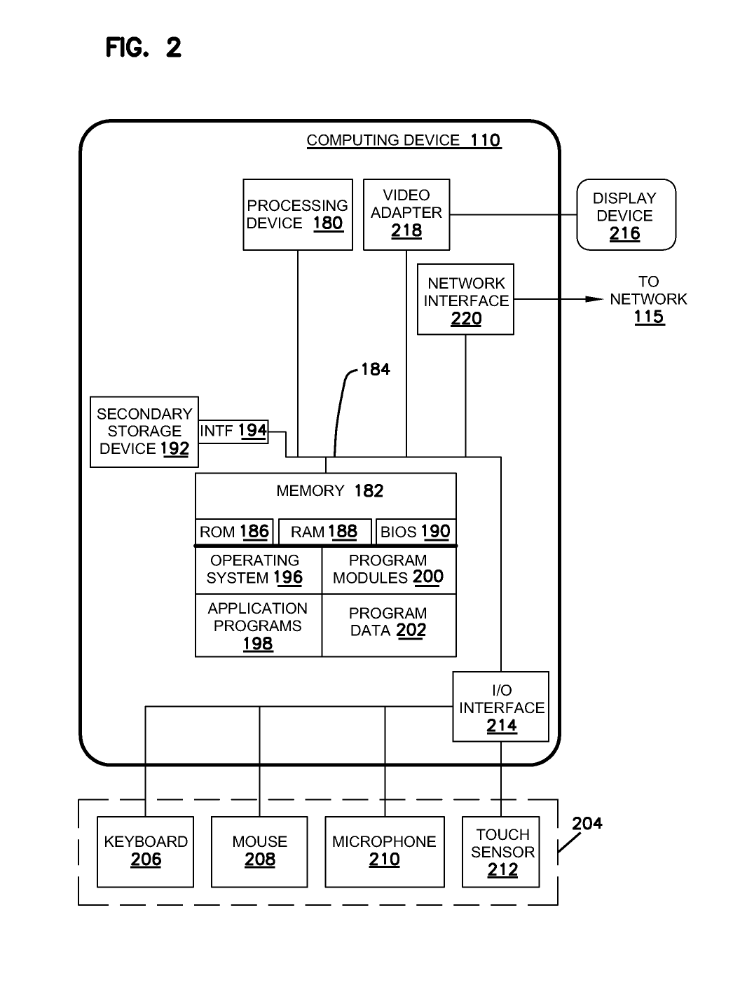

FIG. 2 illustrates an exemplary architecture of a computing device that can be used to implement aspects of the present disclosure, including any of the plurality of business computing devices 108 and 110, server computing device 116, or consumer computing devices 120 and 122. The computing device illustrated in FIG. 2 can be used to execute the operating system, application programs, and software modules (including the software engines) described herein. By way of example, the computing device will be described below as the server computing device 116.

To avoid undue repetition, this description of the computing device will not be separately repeated herein for each of the other computing devices, including business computing devices 108 and 110 and consumer computing devices 120 and 122, but such devices can also be configured as illustrated and described with reference to FIG. 2, or with only minor modifications. For example, smart phone 122 may include a touch sensitive display 212 within the housing, rather than separate display device 216 and touch sensor 212 located outside of the housing. Similarly, mouse 208 may be other pointer control devices, such as the touch sensitive display, a trackball, a touch pad, or other pointer control devices.

The computing device 116 includes, in some embodiments, at least one processing device 180, such as a central processing unit (CPU). A variety of processing devices are available from a variety of manufacturers, for example, Intel or Advanced Micro Devices. In this example, the computing device 116 also includes a system memory 182, and a system bus 184 that couples various system components including the system memory 182 to the processing device 180. The system bus 184 is one of any number of types of bus structures including a memory bus, or memory controller; a peripheral bus; and a local bus using any of a variety of bus architectures.

Examples of computing devices suitable for the computing device 116 include a desktop computer, a laptop computer, a tablet computer, a mobile computing device (such as a smart phone, an iPod® or iPad® mobile digital device, or other mobile devices), or other devices configured to process digital instructions.

The system memory 182 includes read only memory 186 and random access memory 188. A basic input/output system 190 containing the basic routines that act to transfer information within computing device 116, such as during start up, is typically stored in the read only memory 186.

The computing device 116 also includes a secondary storage device 192 in some embodiments, such as a hard disk drive, for storing digital data. The secondary storage device 192 is connected to the system bus 184 by a secondary storage interface 194. The secondary storage devices 192 and their associated computer readable media provide nonvolatile storage of computer readable instructions (including application programs and program modules), data structures, and other data for the computing device 116.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 192 or memory 182, including an operating system 196, one or more application programs 198, other program modules 200 (such as the software engines described herein), and program data 202. The computing device 116 can utilize any suitable operating system, such as Microsoft Windows™, Google Chrome™, Apple OS, and any other operating system suitable for a computing device. Other examples can include Microsoft, Google, or Apple operating systems, or any other suitable operating system used in tablet computing devices.

In some embodiments, a user provides inputs to the computing device 116 through one or more input devices 204. Examples of input devices 204 include a keyboard 206, mouse 208, microphone 210, and touch sensor 212 (such as a touchpad or touch sensitive display). Other embodiments include other input devices 204. The input devices are often connected to the processing device 180 through an input/output interface 214 that is coupled to the system bus 184. These input devices 204 can be connected by any number of input/output interfaces, such as a parallel port, serial port, game port, or a universal serial bus. Wireless communication between input devices and the interface 214 is possible as well, and includes infrared, BLUETOOTH® wireless technology, 802.11a/b/g/n, cellular, or other radio frequency communication systems in some possible embodiments.

In this example embodiment, a display device 216, such as a monitor, liquid crystal display device, projector, or touch sensitive display device, is also connected to the system bus 184 via an interface, such as a video adapter 218. In addition to the display device 216, the computing device 116 can include various other peripheral devices (not shown), such as speakers or a printer.

When used in a local area networking environment or a wide area networking environment (such as the Internet), the computing device 116 is typically connected to the network 115 through a network interface, such as an Ethernet interface 220. Other possible embodiments use other communication devices. For example, some embodiments of the computing device 116 include a modem for communicating across the network.

The computing device 116 typically includes at least some form of computer-readable media. Computer readable media includes any available media that can be accessed by the computing device 116. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 116.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 2 is also an example of programmable electronics, which may include one or more such computing devices, and when multiple computing devices are included, such computing devices can be coupled together with a suitable data communication network so as to collectively perform the various functions, methods, or operations disclosed herein.

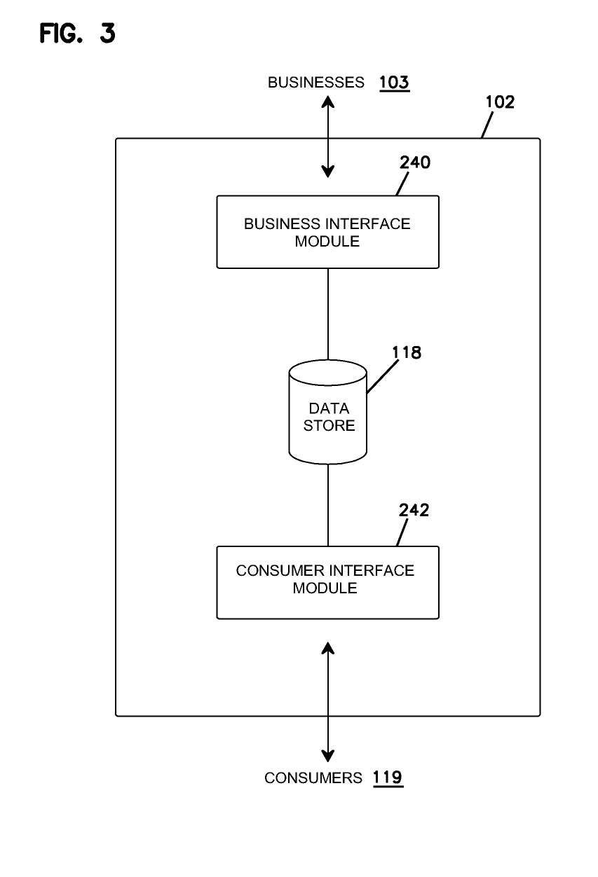

FIG. 3 is a schematic block diagram of the business promotion system 102. In this example, the business promotion system 102 includes a business interface module 240, data store 118, and consumer interface module 242.

In some embodiments, the business interface module 240 and consumer interface module 242 reside on the business promotion system 102 and are defined by program instructions stored in one or more computer readable storage media. The program instructions are executed by programmable electronics, such as including one or processing devices of one or more servers 116 (shown in FIG. 1).

In some embodiments, however, at least some of the business interface module 240 operates on business computing device 108 or 110, such as in the form of scripts or applets, or in the form of software applications. Similarly, in some embodiments at least some of the consumer interface module 242 operates on consumer computing devices 120 and 122, such as in the form of scripts or applets, or in the form of one or more software applications. In such embodiments, the operations of the business computing devices 108 and 110 and server computing device 116 collectively perform the operations of the business interface module 240 described herein. Similarly, the operations of the consumer interface module 242 are collectively performed by the consumer computing devices 120 and 122 and the server computing device 116, in some embodiments.

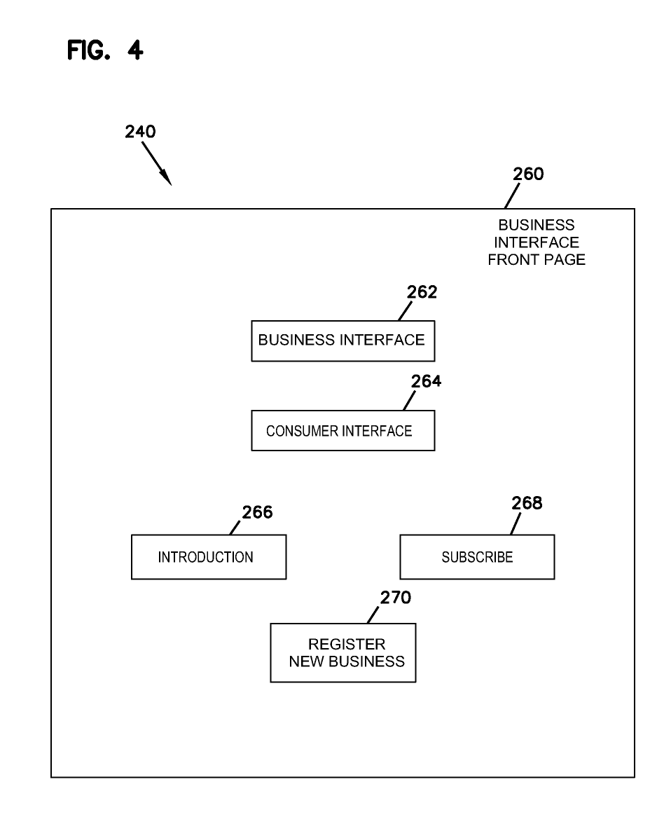

Business interface module 240 is a portion of the business promotion system 102 that interfaces with businesses 103, shown in FIG. 1. Business interface module 240 is described in more detail herein with reference to example embodiments shown in FIGS. 4-12.

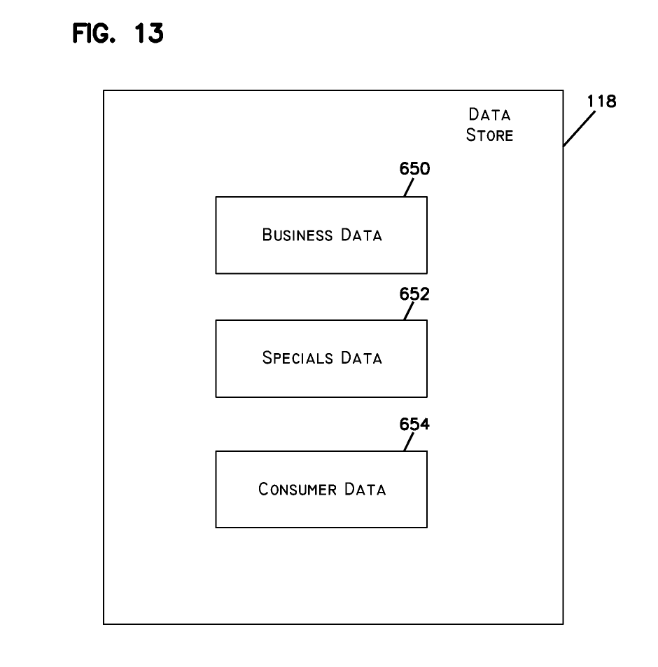

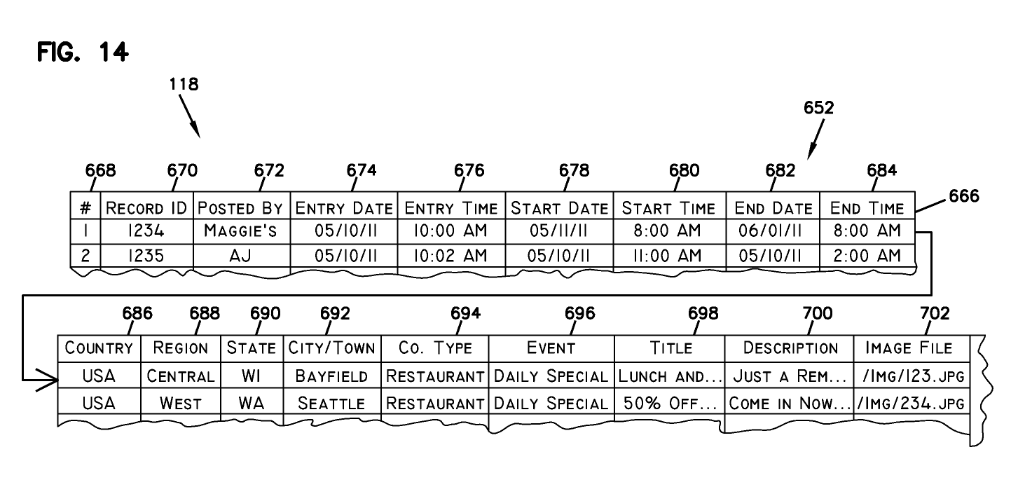

Data store 118 includes one or more computer readable storage media that store digital data used by the business promotion system 102. Examples of computer readable storage media are described herein with reference to FIG. 2. In some embodiments data store 118 includes a database. Data store 118 is part of server 116 (shown in FIG. 1) in some embodiments. In other embodiments, data store 118 is separate from, but in data communication with, server 116. Data store 118 is described in more detail herein with reference to example embodiments shown in FIGS. 13-14.

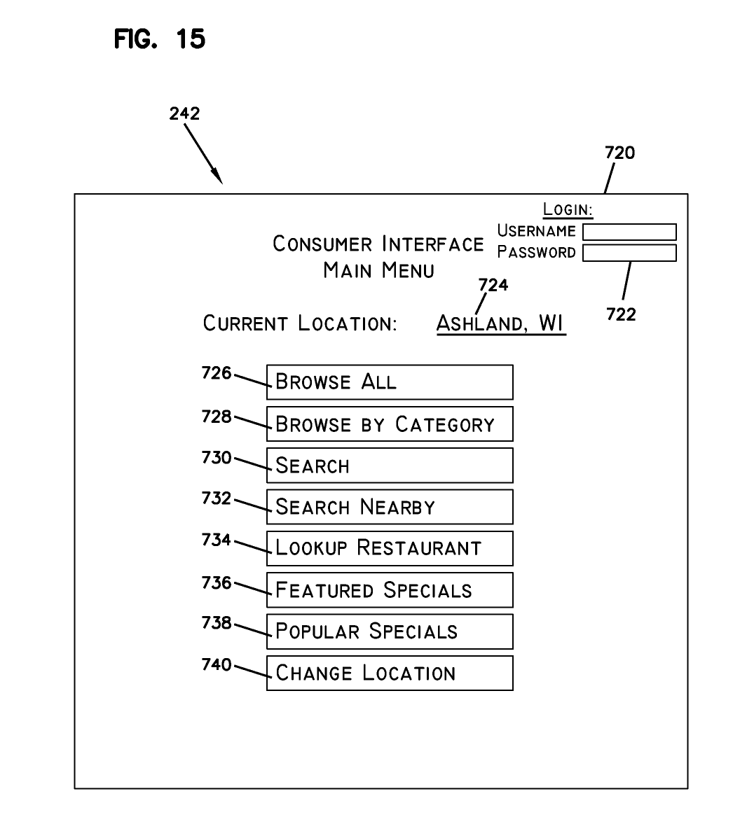

Consumer interface module 242 is a portion of the business promotion system 102 that interfaces with consumers 119, shown in FIG. 1. Consumer interface module 242 is described in more detail herein with reference to example embodiments shown in FIGS. 15-20.

FIGS. 4-12 illustrate example embodiments of business interface module 240, shown in FIG. 3.

FIG. 4 is a screen shot of an example user interface display 260 generated by the business interface module, and displayed on a business computing device 108 or 110 (shown in FIG. 1).

In some embodiments, a business representative 112 or 114 provides input to computing device 108 or 110 to access the business interface module 240, such as by entering a URL for a web site associated with the business interface module 240, or by selecting a shortcut to the web site on the desktop of the business computing device 108 or 110, or by executing a software application on the business computing device 108 or 110. In some embodiments, display 260 is then displayed on business computing device 108 or 110.

Display 260 can include various introductory information and graphics to welcome the business representative, and also includes selectable controls, such as controls 262, 264, 266, 268, and 270, which can be selected by the business representative to cause the business interface module 240 to perform various operations.

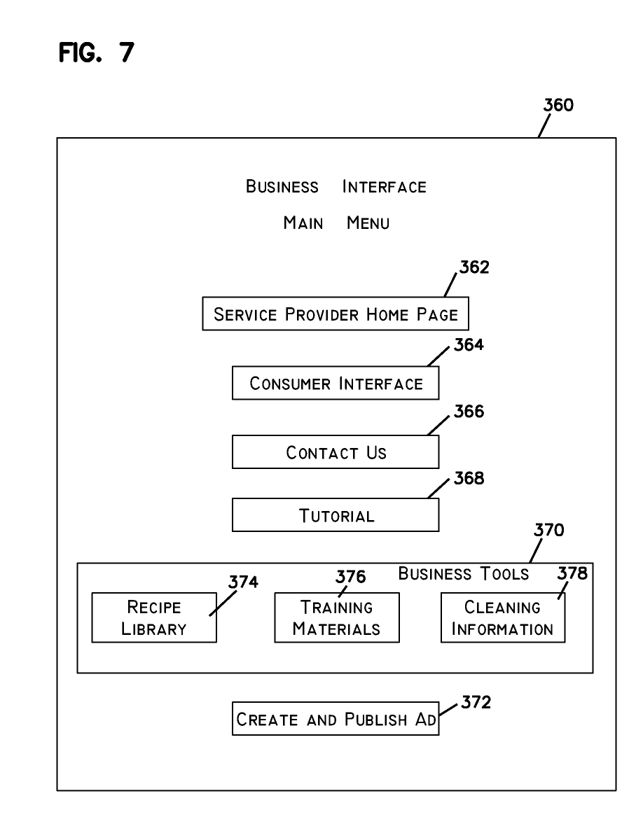

If the restaurant is already registered with the business promotion system 102 (FIG. 1), control 262 can be selected to continue with the business interface module 240. In some embodiments, the business interface module 240 then prompts the business representative 112 to enter a username and password associated with restaurant 104. Alternatively, or after logging in, the business interface module 240 proceeds to display the main menu, shown in FIG. 7. In some embodiments each of the businesses 103 has its own username and password. In other embodiments, each business representative 112 has his or her own username and password and is associated with one of the businesses 103 to permit the business representative 112 to add, edit, or remove information in the business promotion system 102 (FIG. 1) associated with the respective business.

If, instead of proceeding with the business interface module, the user desires to access the consumer interface module 242 (FIG. 3), control 264 is provided that is linked to the consumer interface module 242 (FIG. 3), such as to the page shown in FIG. 15.

Various additional information or tools can also be provided in some embodiments of display 260. For example, control 266 is provided to provide the business representative with additional information about the business promotion system 102 (FIG. 1). In some embodiments, upon selection of the control 266, the business representative is presented with a display that contains additional information. The presentation may include a display including a video, text, a slide show, an animated tutorial, or other information about the business promotion system 102. For example, some embodiments present a promotional slide show presentation. The slide show presentation includes a graphical portion illustrating aspects of the business promotion system, and a text portion providing a written narrative explaining the activities that will be performed on those screens. Each screen also has an audio clip associated with it that further explains each screen, in some embodiments. Some embodiments further include screens that describe the operation of the business interface module, and screens that encourage the businesses viewing the slide show to subscribe to the services provided by the business promotion system.

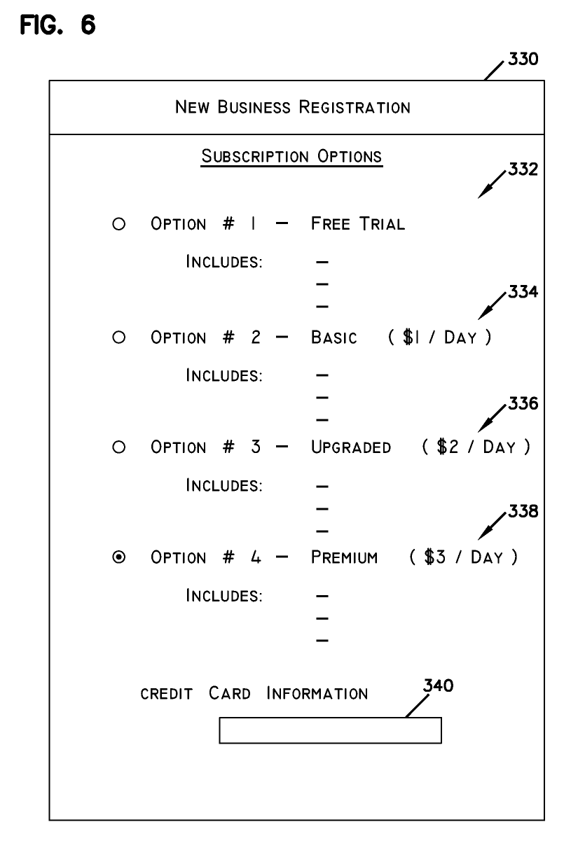

Subscribe control 268 is provided on display 260 in some embodiments to initiate a subscription process. Business representative 112 selects subscription control 268 if the business representative 112 would like to subscribe to the business promotion system, or would like more information about subscription options. Upon selection of the control 268, the subscription options are presented, as shown in FIG. 6.

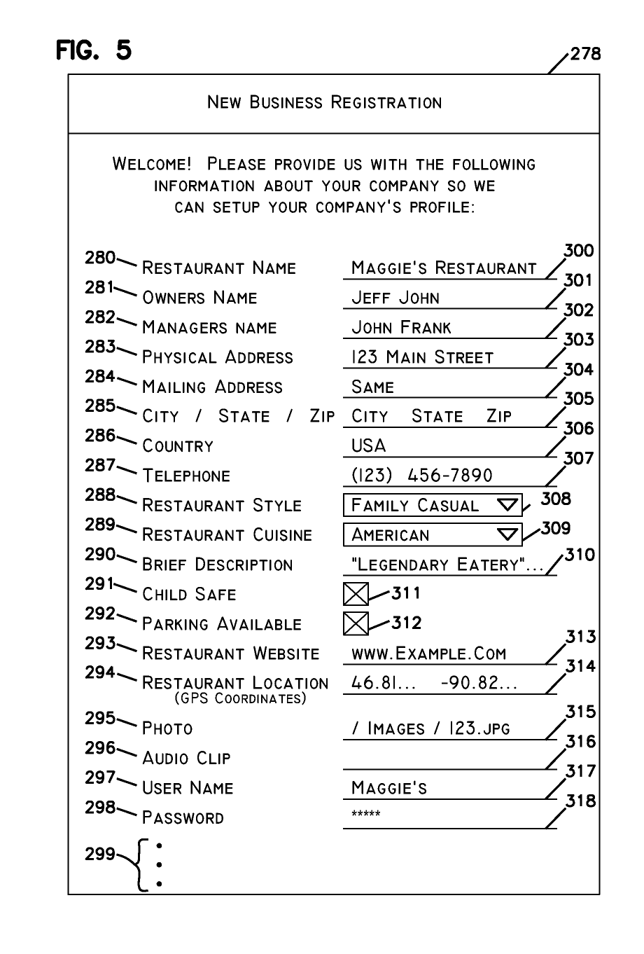

If the restaurant has not previously registered with the business promotion system 102 (FIG. 1), the register new business control 270 can be selected. Upon selection of control 270, the new business registration process is initiated by the business interface module 240, as shown in FIG. 5.

Additional information and more or fewer controls can be provided on display 260 in other embodiments.

FIG. 5 is a screen shot of an example new business registration page 278 generated by the business interface module 240. In this example, the new business registration page 278 requests various information from the business representative by displaying a plurality of prompts 280-298, and receives the information from the business representative at a plurality of data input fields 300-318.

In this example, the prompts include prompts for the restaurant name (280), owners name (281), managers name (282), physical address (283), mailing address (284), city/state/zip code (285), country (286), telephone number (287), restaurant style (288), restaurant cuisine (289), brief description (290), child safe (291), parking availability (292), restaurant website (293), restaurant location (294), photograph (295), audio clip (296), username (297), password (298), and any other desired information (299). Examples of other information 299 includes: alternative telephone numbers, detailed description of restaurant, link to social networking pages (e.g., Facebook, Twitter, YouTube, MySpace) or other associated web pages, photograph of restaurant, photographs of menu items, the name of a community/service area food pantry, or other information or data.

Although the example shown in FIG. 5 is specifically directed to restaurants, some embodiments include a new business registration that is not specifically directed to restaurants. In this example, the business registration display 278 may prompt for the businesses name (rather than restaurant name), company type (e.g., hardware store, restaurant, hotel, sporting goods store, auto repair shop, etc.), business web site, business location, etc.

In an example embodiment, some of the data input fields (e.g., 300-307) are text entry fields that permit the restaurant representative 112 to enter a set of alphanumeric characters (e.g., ASCII characters), such as up to a maximum number of characters. Some, the data fields (e.g., 308-309) are drop-down menus that only permit the restaurant representative 112 to select from a limited set of options. In another embodiment, data input fields are check boxes (e.g., 311 and 312), radio buttons, or other selectable controls that permit the business representative 112 to select between a limited set of options. Some data fields (e.g., 315 and 316) permit the business representative 112 to upload a file from the business computing device 108 or 110.

In the example shown in FIG. 5, the restaurant representative has provided the following information into the data entry fields 300-318 for each of the respective prompts 280-298: Maggie's Restaurant (300), Jeff John (301), John Frank (302), 123 Main Street (303), Same (304), CITY STATE ZIP (305), USA (306), (123) 456-7890 (307), Family Casual (308), American (309), “Legendary Eatery” . . . (310), child safe (311), parking available (312), www.example.com (313), 46.81 . . . −90.82 . . . (314), /images/123.jpg (315), no audio clip (316), Maggie's (317), and a confidential password (318).

Examples of available restaurant styles (288) that can be selected with data entry field 308 include: fine dining—classy, family casual, fast food, bar and grill, off-the-wall crazy, and theme/chain.

Examples of available restaurant cuisines (289) that can be selected with data entry field 309 include: American, Native American, French, German, Italian, Indian, Chinese, Japanese, Other Far Eastern, Spanish/Mexican, and Variety.

In some embodiments, each business is associated with a location, which can be provided identified in one or more forms. For example, prompts 283, 285, and 286 prompt the business representative to enter the businesses physical address, including a street address, city, state, zip code, and country. Similarly, prompt 294 prompts the user to enter the businesses GPS coordinates. If the coordinates are not known, in some embodiments the GPS location is automatically identified by the business promotion system 102 based on the physical address. In another possible embodiment, a map is displayed to permit the business representative to identify or confirm the location of the restaurant on a geospatially aligned map to identify the GPS coordinates.

FIG. 6 is a screen shot of an example subscription display 330 generated by the business interface module 240, shown in FIG. 3. The subscription display 330 provides the business representative with information about one or more subscription or membership options, and permits the guides the business representative in the subscription or membership processes.

In this example, the subscription display 330 presents three different business subscription options, including a free trial subscription option 332, basic subscription option 334, upgraded subscription option 336, and a premium subscription option 338. In some embodiments, each subscription option is associated with a subscription fee. For example, the free trial has no cost, the basic subscription is $1/day, the upgraded subscription is $2/day, and the premium subscription is $3/day. Any other values can be charged for the various subscription options. Some embodiments charge fees based on other time periods (e.g., weekly, monthly, annual, multi-annual, etc.) Some embodiments charge flat fees.

In some embodiments, each of the various subscription levels are associated with different sets of features and services that are provided by the business promotion system. For example, the free trial may only permit the business representative to view various screens, but not permit the business representative to publish advertisements to the consumer interface module 242 (FIG. 3). The free trial may provide access to free tools, such as the recipe library, training materials, and cleaning information described herein (see FIG. 7). On the other hand, paid subscribers are given access to other features and services, such as the ability to publish limited or unlimited advertisements, inclusion of the restaurant in featured restaurant lists or with special display characteristics (e.g., highlighting), or promotion of the restaurant in search results presented to consumers by the consumer interface module.

Upon selection of the desired option, display 330 also includes one or more data entry fields 340 for receiving payment information, such as a credit card number, billing name and address, expiration date, and card security code.

In some embodiments, after the registration and/or subscription processes have been completed, the business interface module 240 displays the main menu as shown in FIG. 7

FIG. 7 is a screen shot of an example main menu display 360 generated by the business interface module 240 and displayed on the business computing device 108 or 110. In some embodiments, the main menu display 360 includes a variety of selectable controls that can be selected by the business representative to initiate various available operations of the business interface module 240.

In this example, the selectable controls include service provider home page control 362, consumer interface control 364, contact us control 366, tutorial control 368, business tools 370 (including recipe library control 374, training materials control 376, and cleaning information control 378), and publish ad control 372. Other embodiments include additional information or content in display 360, and can include more or fewer controls.

Service provider home page control 362 provides a link to permit the business representative to access the home page of the service provider of the business promotion system 102. The site can be accessed by business representatives in order to check for program or system updates and upgrades, other products and business promotions, customer support, and technical support.

Consumer interface control 364 provides a link to the consumer interface module 242 (FIG. 3), such as to the display shown in FIG. 15. This allows the business representative to quickly access the consumer interface, such as to see how information that has been entered by the business representative will be displayed to consumers 119. For example, the business representative can check to be sure that the company's daily specials and promotions have been published.

Contact us control 366 can be selected to cause the business interface module 240 to provide the business representative with contact information for the service provider of the business promotion system 102. The contact information can include, for example, a name, a telephone number, mailing address, e-mail address, web address, live chat interface, or other contact information. The information can be used by the business representative to obtain technical support, make billing inquiries, talk with a sales representative, general customer service, or for other purposes. In some embodiments the service provider is the developer of the system or software.

Tutorial control 368 can be selected to initiate a tutorial process to educate the business representative. In some embodiments, a tutorial display is presented by the business interface module after selection of control 368. The tutorial display includes information and graphical displays that guide the business representative, screen-by-screen, through the various displays and functionality provided by the business interface module 240. In some embodiments, the tutorial display includes a text description displayed adjacent graphical representations of certain displays of the business interface module 240. Some embodiments employ search capabilities which allow the business representative to enter one or more search terms related to that which they are questioning, and the related records will be found and displayed in the tutorial display.

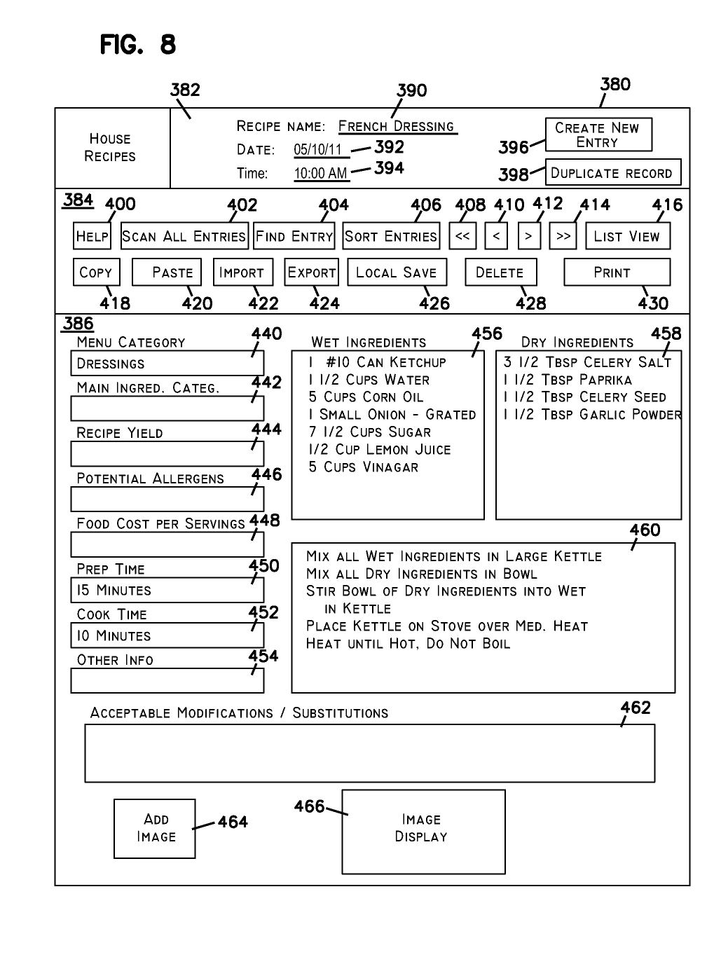

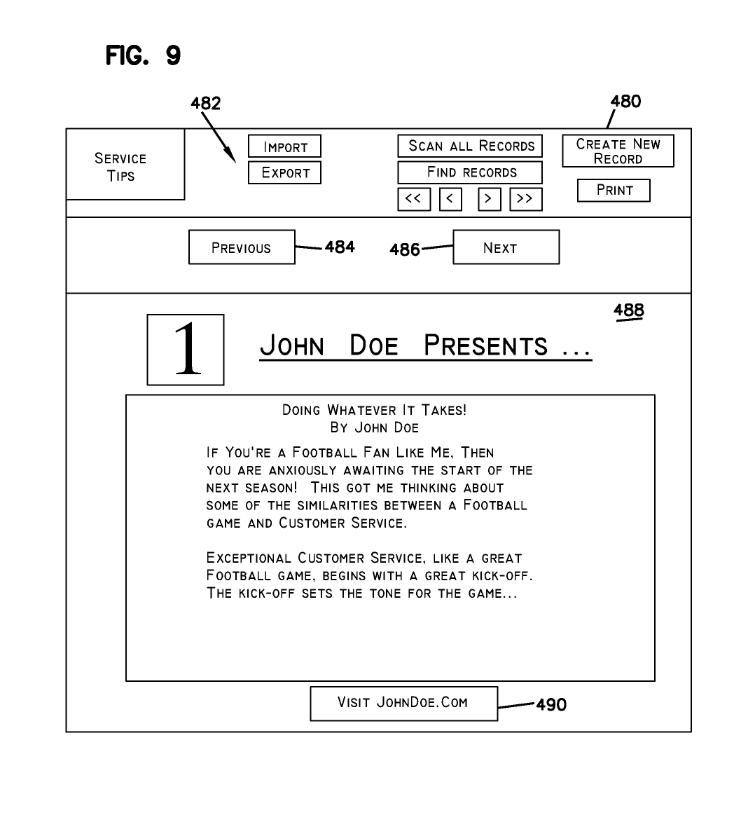

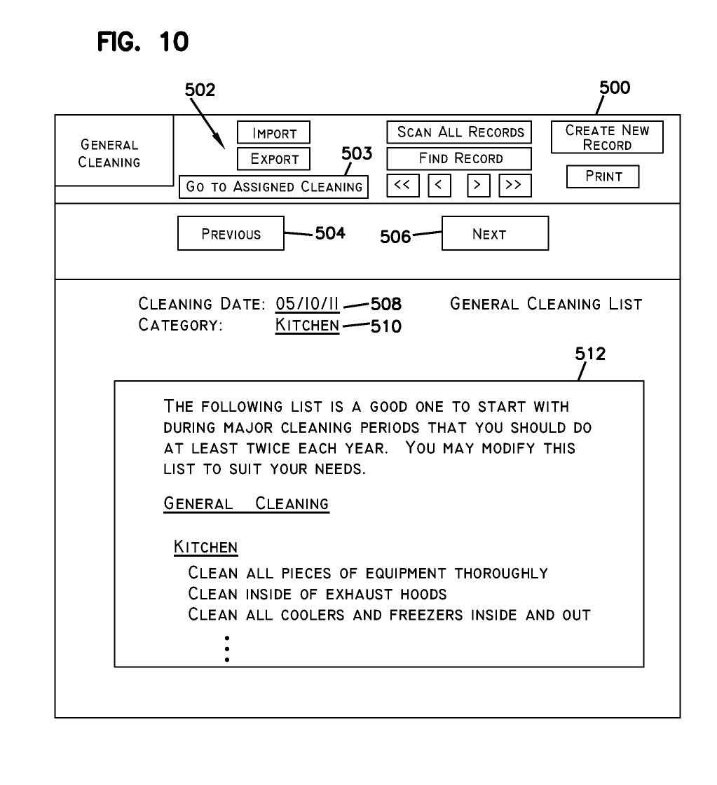

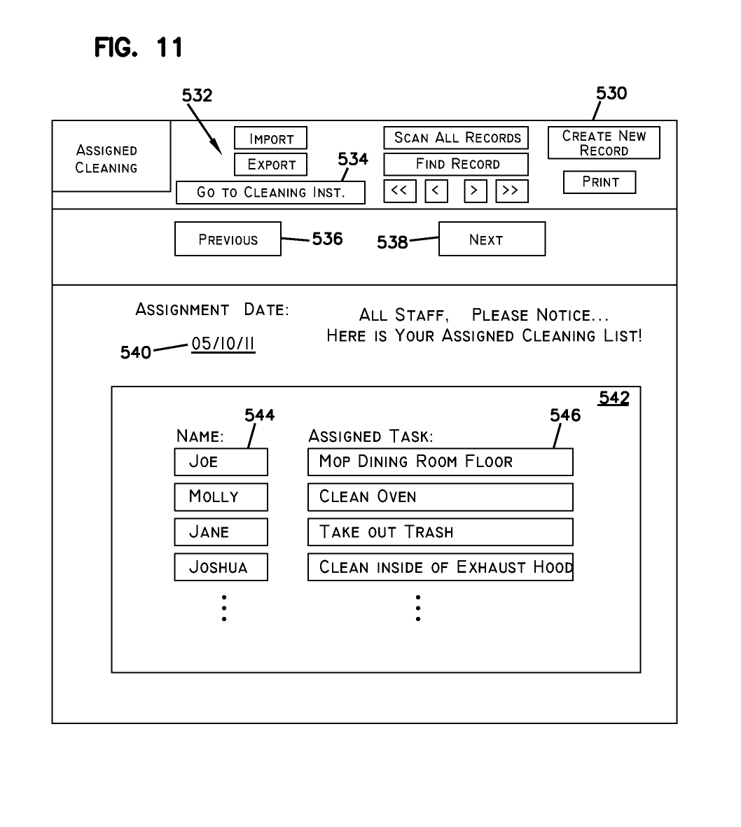

In some embodiments, business promotion system provides one or more business tools that can assist businesses with business operations (such as non-advertising business operations). Examples of the business tools include a recipe library tool, training materials tool, and cleaning tool. Selection of the recipe library control 374 initiates the recipe library tool, which is described in more detail with reference to FIG. 8. Selection of the training materials control 376 initiates the training materials tool, which is described in more detail with reference to FIG. 9. Selection of the cleaning information control 378 initiates the cleaning tool, which is described in more detail with reference to FIGS. 10-11.

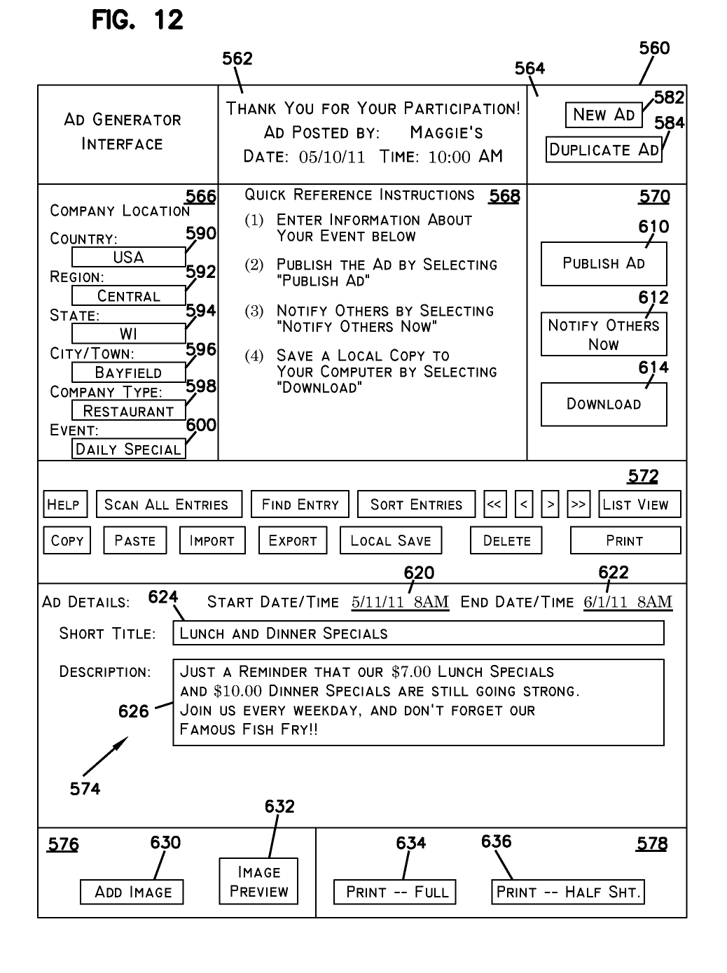

Publish ad control 372 can be selected to manage advertisements, including creating, editing, or removing advertisements associated with the business representative's business. Advertisement management and publishing is described in more detail with reference to FIG. 12.

FIG. 8 is a screen shot of an example recipe display 380 of a recipe tool provided by the business interface module 240. The recipe tool is used specifically by restaurant businesses to create and organize their house recipes. In some embodiments the recipe tool maintains all of the house recipes in a common location where they can be easily accessed by business representatives. In some embodiments, the recipe tool ensures that all staff members prepare various menu items in the same way so that the food prepared is consistent in taste.

The recipe tool typically includes at least a list display that provides a list of all of the house recipes, and a recipe display 380 that provides details about each recipe. The list display is not separately illustrated, but includes, for example, a list of the title of each recipe. In some embodiments, the list display organizes the recipes into groups or such as using a folder or tree structure.

Turning now to the example recipe display 380, the display 380 includes a header 382, a toolbar 384, and a recipe details window 386.

The header 382 includes information about the recipe, such as a title 390 and a date 392 and time 394 that the recipe was created or last modified.

The header also includes create new entry control 396 and duplicate record control 398. Create new entry control 396 is selected to cause the business interface module to save changes made to the currently displayed recipe (if any) and open a new blank recipe display that can be filled in by the business representative to enter a new recipe. Duplicate record control 398 is selected to cause the business interface module to open a new recipe display 380, but to include all of the information from the current recipe in the new display. The duplicate record control 398 saves time when a new recipe needs to be entered that is similar to a previously entered recipe. By duplicating the record, only those fields that are different need to be updated by the business representative.

Toolbar 384 includes selectable controls that initiate a variety of tools to assist the business representative in managing recipes. The selectable controls include, for example, a help control 400 that causes help information to be displayed.

If recipe display 380 was accessed through a search, navigation between recipes or further keyword searching can be limited to the previously defined set of search results. The scan all entries control 402 can be selected to define the current set of entries to “all” entries, to essentially clear the previous search. This permits subsequent operations, such as navigation or searching to be performed against all recipes, rather than being limited to the specific search results.

Find entry 404 is selected to initiate a recipe search operation. Sort entries 406 is selected to define a desired order for the recipes to be arranged in (e.g., alphabetical, by date, by menu category, etc.). The selected order is then used for the list display and for navigation between recipes.

Navigation controls 408, 410, 412, and 414 are provided to permit the business representative to navigate through the various recipes. Control 408 is selected to display the first recipe in the set, and control 414 is selected to display the last recipe in the set. Control 410 is selected to move to the prior recipe in the set, and control 412 is selected to move to the next recipe in the set.

List view control 416 causes the recipe tool to generate the list display, showing a list of all recipes in the current set. The list view may include a text description of each recipe in the list, and may also include an image depicting the item. Copy and paste controls 418 are selected to copy and paste selected information or records. Import and export controls 422 and 424 are selected to move one or more recipes between the business interface module and the business computing device 108 or 110 (FIG. 1). Local save control 426 is selected to save the current recipe to the business computing device 108 or 110 (FIG. 1). Delete control 428 is selected to delete the current recipe. Print control 430 is selected to print the current recipe or set of recipes to a printer associated with the business computing device 108 or 110.

Recipe details window 386 includes various data entry and display fields that receive and display details of a recipe. In this example, the details window 386 includes the following data fields: menu category 440, main ingredient category 442, recipe yield 444, potential allergens 446, food cost per serving 448, preparation time 450, cook time 452, other information 454, wet ingredients list 456, dry ingredients list 458, directions 460, and list of acceptable modifications or substitutions 462.

If desired, one or more images can be included with the recipe by selecting the add image control 464. Once the image has been provided, the image is displayed in image display 466.

In some embodiments, data associated with the recipe tool is stored in data store 118 (FIG. 1).

FIG. 9 is a screen shot of an example training materials display 480 of a training materials tool generated by the business interface module 240 and displayed on business computing device 108 or 110. The training materials display 480 manages instructional, educational, motivational, and other information for businesses to help train business staff on any desired topic associate with the business, such as how to provide good service to customers.

In some embodiments, at least some of the content provided by the training materials tool is provided by the service provider of the business promotion system 102. In other embodiments, at least some of the content is provided by a business representative. In some embodiments, the training materials tool also includes additional pages (not specifically shown), such as a list display of the available training materials, which includes at least a text-based list of titles of training materials that are available.

Training materials display 480 provides an interface to create, review, or edit the training materials. In this example, training materials display 480 includes a header 482, navigation controls 484 and 486, and content window 488.

In some embodiments the header 482 includes selectable controls operable to initiate various tools, such as import and export tools, search tools, navigation controls, a create new record tool, and a print tool. These tools are similar to the tools provided by toolbar 384 (FIG. 8) and therefore will not be separately described in further detail here.

Navigation controls 484 and 486 can be selected to cause the training materials tool to display the previous or next training material display in the series.

Content window 488 displays the content for the training material. In this example, the training material is a service tip provided by a well known expert in the restaurant industry. The content is provided in the form of a short article. In other embodiments, the content can take any desired form and include any desired media, such as audio, video, images or other graphics, animations, slide presentations, etc. The content may also include tools such as a link control 490. In this example, the link control 490 is linked to the author's web site where the business representative can obtain more information or access additional resources from the author.

In some embodiments some or all of the training materials are available for a fee from the service provider of the business promotion system. In other embodiments, some or all of the training materials are made available for free.

In some embodiments, data associated with the training materials is stored in data store 118 (FIG. 1).

FIG. 10 is a screen shot of an example cleaning instructions display 500 of a cleaning tool generated by the business interface module 240 and displayed on business computing device 108 or 110. The cleaning instructions display 500 manages instructions and cleaning procedures for the business. The cleaning instructions define procedures for maintaining the business clean, sanitary, and free from cross-contamination issues, for example.

In some embodiments, at least some of the content provided by the cleaning tool is provided by the service provider of the business promotion system 102. In other embodiments, at least some of the content is provided by a business representative. In some embodiments, the cleaning tool also includes additional pages (not specifically shown), such as a list display of the available cleaning information, which includes at least a text-based list of titles of cleaning information displays that are available.

Cleaning instructions display 500 provides an interface to create, review, or edit the cleaning instructions and information. In this example, cleaning instructions display 500 includes a header 502, navigation controls 504 and 506, cleaning date display 508, cleaning category display 510, and content window 512.

In some embodiments the header 502 includes selectable controls operable to initiate various tools, such as import and export tools, search tools, navigation controls, a create new record tool, and a print tool. Most of these tools are similar to the tools provided by toolbar 384 (FIG. 8) and therefore will not be separately described in further detail here.

Header 502 further includes assigned cleaning control 503, in this example. The control 503 is selected to cause the cleaning tool to display the assigned cleaning display, as shown in FIG. 11.

Navigation controls 504 and 506 can be selected to cause the cleaning instructions display 500 to display the previous or next cleaning instruction display in the series.

Cleaning date display 508 displays the date that the instructions described in content window 512 should be completed. By assigning specific dates to instructions, the cleaning can be associated with a cleaning schedule, such as described in more detail with reference to FIG. 11. Periodic cleaning schedules can be defined to ensure that certain cleaning activities occur periodically to maintain a clean and sanitary environment.

Category display 510 shows a category to which the instructions belong. This permits instructions to be grouped, listed, searched, and sorted by category.

Content window 512 displays the specific instructions. For example, the instructions illustrated in FIG. 10 describe a general kitchen cleaning procedure that should be performed at least twice each year.

In some embodiments some or all of the cleaning instructions are available for a fee from the service provider of the business promotion system. In other embodiments, some or all of the cleaning instructions are made available for free. In yet other embodiments, some or all of the cleaning instructions are provided by business representatives.

In some embodiments, data associated with the cleaning instructions is stored in data store 118 (FIG. 1).

FIG. 11 is a screen shot of an example assigned cleaning display 530, such as provided by the cleaning tool of the business interface module 240 (FIG. 3) and displayed at business computing device 108 or 110. Assigned cleaning display 530 manages cleaning assignments for a business, by defining a set of cleaning tasks needed to be performed on a given day, and assigning those tasks to specific people in the business.

In some embodiments, at least some of the cleaning tasks are provided by the service provider of the business promotion system 102. In other embodiments, at least some of the content is provided by a business representative.

Assigned cleaning display 530 provides an interface to create, review, or edit the cleaning assignments. In this example, assigned cleaning display 530 includes a header 532, navigation controls 536 and 538, assignment date display 540, and assignment window 542.

Header 532 includes many similar tools to those provided by toolbar 384 (FIG. 8) and therefore such tools will not be separately described in further detail here. Header 502 further includes cleaning instructions control 534, in this example. The control 534 is selected to cause the cleaning tool to display the cleaning instruction display(s) (shown in FIG. 10) that are associated with the assigned cleaning tasks, so that the business representative can obtain more information about how to perform the assigned cleaning tasks.

Navigation controls 536 and 536 can be selected to cause the assigned cleaning display 530 to display the cleaning assignments for the previous or next day.

Assignment date display 540 displays the date that the assigned tasks should be completed, and as a result, the assigned tasks are associated with a cleaning schedule.

Assignment window 542 identifies the particular cleaning tasks that should be completed, and the person or persons assigned to complete the task. In this example, assignment window 542 includes a list of assigned tasks 546. For each task, one or more people are identified in the assignment list 544 to identify the names of the people that are assigned to the tasks identified in the assigned tasks 546. In some embodiments the assignment window 542 includes selectable controls, such as check boxes, that can be selected by the business representative when each task is completed. An alert is generated in some embodiments if one or more of the assigned tasks is not completed on the assignment date shown in assignment date display 540. The alert can include a message displayed by the business interface module, a message (e.g., text-message, e-mail, fax, telephone, voicemail, etc) to the business owner, manager, or other business representative, an audible alert, or a variety of other possible alerts to inform a business representative that an assigned task was not completed according to the cleaning schedule.

In some embodiments, data associated with the cleaning assignments is stored in data store 118 (FIG. 1).

FIG. 12 is a screen shot of an example advertisement generator display 560 of an advertisement generator tool of business interface module 240 (FIG. 3). The advertisement generator is used by a business representative to prepare advertisements for the business, which can be published to the consumer interface module 242 (FIG. 3), e-mailed (or otherwise communicated) to consumers, and/or printed for display or distribution by the business.

In this example, advertisement generator display 560 includes a header 562, record controls 564, advertisement tagging controls 566, instructions 568, communication controls 570, toolbar 572, ad details window 574, image window 576, and print controls 578.

Header 562 displays introductory information about the currently displayed advertisement, such as the username of the business representative that prepared the advertisement and the date and time that the advertisement was prepared or last updated.

Record controls 564 include a new ad control 582 and duplicate ad control 584. The new ad control 582 can be selected to display a new advertisement generator display without any data filled in. Duplicate ad control 584 can be selected to display a new advertisement generator display that contains all of the data from the currently displayed advertisement generator display 560. To use the duplicate ad control 584, the business representative can, for example, perform a search or browse to a previously created advertisement that is similar to a new advertisement that the business representative wants to prepare. The duplicate ad control 584 is then selected, which causes the duplicate ad to be displayed with all of the same data as previously entered. The business representative then makes appropriate modifications (such as to modify the start and/or end date). This process reduces amount of time and amount of data entry required to prepare an advertisement that is similar to a previously prepared advertisement.

Advertisement tagging controls 566 are provided to permit the business representative to associate the advertisement with certain information. In some embodiments, tagging controls 566 are drop-down menus that include only a limited number of available standard options. By providing a standard set of options, variations in spelling, words, and the like is eliminated, such as to provide improved search results.

In this example, the advertisement tagging controls 566 include company location controls 590, 592, 594, and 596, company type control 598, and event type control 600. In this example, the company location controls include a country control 590 (e.g., USA), region control 592 (e.g., central), state or province control 594 (e.g., WI), and city/town control 596 (e.g., Bayfield). Examples of possible company types (598) include restaurant, hotel, sporting goods store, auto repair shop, hardware store, or a variety of other possible company types. Examples of possible event types (600) include special offer, daily special, news, special event, or a variety of other possible event types.

Instructions 568 provide a brief set of instructions to the business representative that describes how to produce, publish, or otherwise communicate the advertisement. In this example, the instructions state: “Quick Reference Instructions: (1) enter information about your event below, (2) publish the ad by selecting ‘publish ad,’ (3) notify others by selecting ‘notify others now,’ (4) save a local copy to your computer by selecting download.”

Communication controls 570 include, for example, publish ad control 610, notification control 612, and download control 614. After entry of an advertisement has been completed in the advertisement generator display, the communication controls 570 can be used to communicate or otherwise transfer the advertisement. For example, the publish ad control 610 is selected to indicate that the advertisement is ready for distribution to the consumer interface module 242 (FIG. 3). Upon selection of the control 610, the advertisement data stored in data store 118 (FIG. 3) is tagged as ready for publication, such that the consumer interface module 242 begins publication of the advertisement during the defined publication period (discussed below), or alternatively, the advertisement data is transferred to a separate data store associated with the consumer interface module 242.

In some embodiments, the business interface module 240 permits businesses to communicate with consumers in real-time. In other words, upon selection of the publish ad control 610, the advertisement is made available in the consumer interface module promptly thereafter, so long as the current date is equal to or after the start date assigned to the advertisement. In some embodiments, the advertisement is made available as soon as the data in the database can be updated by the business promotion system. In some embodiments, the publication of an advertisement does not require the approval, review, posting, or other interaction of any other user, administrator, or person, other than the business representative that enters the information. Instead, publication occurs automatically by the business promotion system after the business representative requests that the information be published. Some embodiments permit the business representative to directly communicate with the consumers without requiring the interactions of other people in between.

The business promotion system expands the business's ability to interact with consumers. Instead of limiting interaction to the brief period of time that the consumer is actually in the store, the business promotion system permits the business to have frequent and near instantaneous communication with consumers or potential consumers at any time of the day or night.

Notification control 612 is selected to initiate communication of the advertisement to others. In some embodiments, upon selection of the notification control 612, another display is generated that prompts the business representative to select the appropriate communication method. Exemplary communication methods include e-mail, text-message, facsimile, automated recording telephone call, and syndication or other communication to social networking sites or other web sites.

Download control 614 can be selected to initiate a transfer of advertisement data for one or more advertisements to the business computing device 108 or 110, such as to permit the business representative to create or edit advertisements offline, and subsequently upload the data to the business interface module.

Toolbar 572 includes a plurality of controls for managing and navigating between advertisement records. The controls and associated tools are similar to or the same as those previously described with reference to toolbar 384 (FIG. 8) and therefore will not be separately described in further detail here.

Ad details window 574 includes data entry fields for defining advertisement content. In this example, ad details window 574 includes start date field 620, end date field 622, title field 624, and description field 626.

Start and end date fields are used to define the publication period for the advertisement. Once the advertisement is tagged for publication (such as by selection of publish ad control 610), the advertisement is placed in the businesses publication queue until the current date is the same as the date indicated by start date 620. At that time, the consumer interface module 242 (FIG. 3) publishes the advertisement to consumers 119. The publication continues until the current date is the same as, or later than, the date indicated by end date 622, or until the advertisement is deleted by a business representative.

Publication of the advertisement typically utilizes data from title field 624 and/or description field 626. For example, a list of search results displayed by the consumer interface module 242 (FIG. 3) may display only the company name and the title 624. A detailed view of the advertisement includes both the title 624 and the description 626. Other embodiments include other data for publication of advertisements.

In some embodiments, advertisements can also include one or more multimedia elements, such as an image, a graphical element, a video, or other multimedia element. In this example, image window 576 includes add image control 630 that can be selected to add an image to the advertisement. A preview of the image is then displayed in image preview 632. Additional information or objects can also be included in some embodiments, such as including code, such as a software applet, script, etc. In some embodiments the advertisement includes an object, such as an interactive chat window to permit consumers to communicate in real time with other consumers or with a business representative.

In some embodiments, advertisements are not coupons, and information contained within the advertisement does not need to be printed or presented to the business by a consumer in order for the consumer to receive a special offer identified in the advertisement (i.e., nonredeemable). In some embodiments, special offers included in an advertisement are offers available to any consumer during the active period of the advertisement.

In some embodiments the advertisement generator can generate printed versions of advertisements. Print controls 578, such as a full-page print control 634 and a half-page print control 636 can be selected by the business representative to initiate the generation of printable advertisements by the advertisement generator. The advertisement generator formats the data entered into advertisement generator display 560 into full-page or half-page printable documents depending on which control is selected. In some embodiments the advertisements are provided as PDFs that can be displayed, saved, and/or printed by the business representative using the business computing device 108 or 110. The printable advertisements can include one or more advertisements. For example, if a restaurant has multiple specials on a given day, the advertisement generator can generate a printable advertisement including all of the specials for that day.

In some embodiments, businesses can use the advertisement generator to instantly publish advertisements, special offers, or other communications or information to the consumer interface module, where it is immediately accessible to consumers. For example, if a restaurant is having a slow day, a restaurant representative can publish an advertisement announcing a special that starts immediately upon publication and ends later that day, to attempt to increase business in the restaurant during the slow period.

In some embodiments, business representatives can publish advertisements as often as desired, as quickly as desired, and including whatever information desired. The advertisement does not have to be limited to a special offer, but can include any information that the business representative wants to communicate to consumers.

FIGS. 13-14 illustrate example embodiments of data store 118, shown in FIGS. 1 and 3.

FIG. 13 is a schematic block diagram of an example data store 118. The data store includes one or more computer readable storage media. In some embodiments, the data store includes two or more computer readable storage media that collectively store data. In some embodiments, the data store is in data communication with one or more server computing devices (or other computing devices), such as server 116 (FIG. 10).

In this example, data store 118 includes business data 650, specials data 652, and consumer data 654. In some embodiments, the data stored in data store 118 is organized in a logical manner, such as in a relational database, in a plurality of data tables, etc.

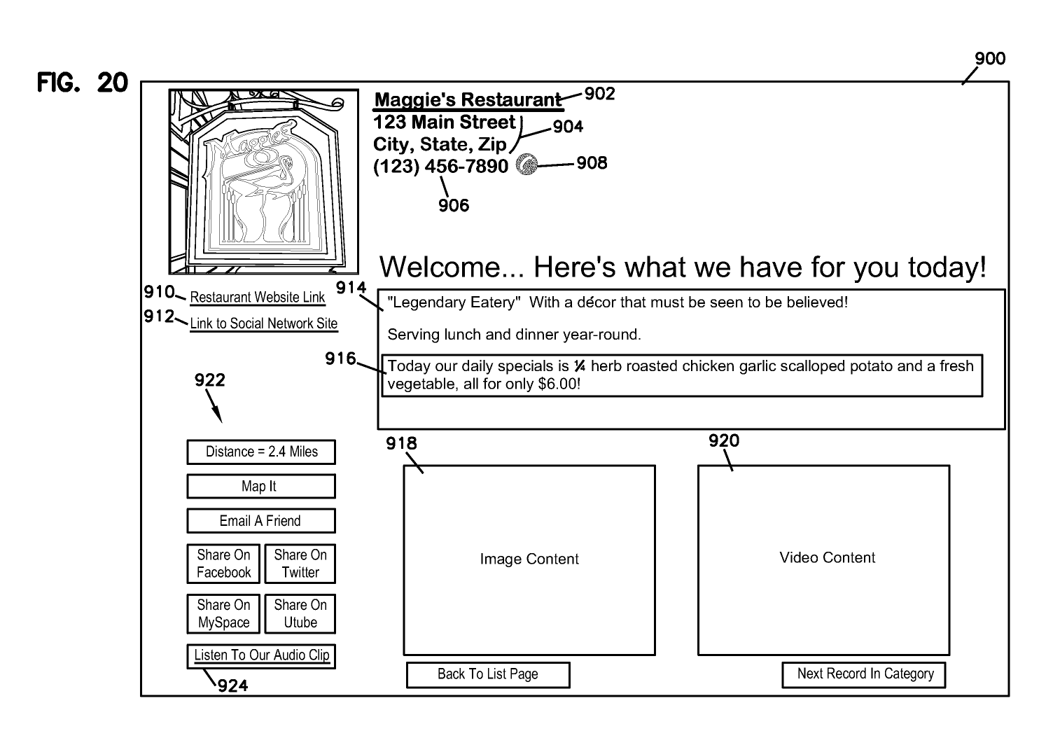

Business data 650 stores information about businesses, such as information received from businesses through the business interface module 240 (FIG. 3). Examples of business data include any of the data received during a new business registration process shown and described with reference to FIG. 5, or any of the data displayed in a business details display, such as shown and described with reference to FIG. 20. For example, business data can include the business name, location data (such as an address and/or GPS coordinate), and other information associated with a business. At least some of business data 650 is received from a business representative. Some embodiments include business data tables, where each table stores data associated with a single business.

Specials data 652 stores promotional or advertising material provided by businesses. In some embodiments, the specials data 652 stores data describing special offers available from businesses. An example of specials data 652 is illustrated and described in more detail with reference to FIG. 14.

Consumer data 654 stores information about consumers, such as information received from consumers through the consumer interface module 242 (FIG. 3). Examples of consumer data include consumer username, password, location (such as home address, business address, current location, and/or GPS coordinates of current location), user preferences, and any other desired information about the consumer. At least some of consumer data 654 is received from the consumer, such as during a consumer registration process, similar to the new business registration process described herein. Some embodiments include consumer data tables, where each table stores data associated with a single consumer.

Additional data is also stored in data store 118 in some embodiments. For example, some embodiments include one or more of recipe data, training materials data, and cleaning data. The recipe data includes any of the data associated with the recipe tool, described herein with reference to FIG. 8. The training materials data includes any of the data associated with the training materials tool, described herein with reference to FIG. 9. The cleaning data includes any of the data associated with the cleaning tool, described herein with reference to FIGS. 10-11.

In some embodiments, data store 118 further includes a search index. The search index contains data that is used by a search engine module to perform quick searches for data contained in data store 118. The search index can include keyword index tables, tag index tables (including location index tables), and a variety of other structures to assist the search engine in quickly and accurately performing a search and providing appropriate search results.

FIG. 14 is a schematic block diagram illustrating an example embodiment of data stored within data store 118. In this example, a portion of the data is shown, which includes specials data 652.

In some embodiments, data within data store 118 is stored in organized data structures, such as a data table 666. The table includes a plurality of records (indicated in this example by record numbers 668), where each record is recorded in a row of the data table 668. Each column of the data table 666 represents a given field of the record.

The illustrated example depicts two of the records, including record 1 and record 2, as indicated in the record number field 668. Each record includes a plurality of data fields, including record identification field 670, posted by field 672, entry date field 674, entry time field 676, start date field 678, start time field 680, end date field 682, end time field 684, country field 686, region field 688, state field 690, city/town field 692, company type field 694, event type field 696, title field 698, description field 700, and image file field 702. These fields are only an example of one possible set of fields that can be contained in records associated with special offers of businesses. Other embodiments include other fields, and may also contain other arrangements of data in data store 118.

Other data stored in data store 118 can be similarly organized within relevant data tables within the data store 118, such as including business data 650 and consumer data 654 (FIG. 13).

FIGS. 15-20 illustrate example embodiments of consumer interface module 242 shown in FIG. 3.

FIG. 15 is a screen shot of an example main menu display 720 of consumer interface module 242, shown in FIG. 3. Consumer interface module 242 operates to interface with consumers 119, such as to convey information about businesses 103 (FIG. 1). In some embodiments, consumer interface module 242 conveys information about special offers available from businesses 103.

In some embodiments, a consumer 124 or 126 provides input to computing device 120 or 122 to access the consumer interface module 242, such as by entering a URL for a web site associated with the consumer interface module 242, or by selecting a shortcut to the web site on the desktop of the consumer computing device 120 or 122, or by executing a software application on the consumer computing device 120 or 122.

In this example, main menu display 720 includes login controls 722, location display 724, and a plurality of selectable menu option controls. The selectable controls include browse control 726, browse by category control 728, search control 730, search nearby control 732, restaurant lookup control 734, featured specials control 736, popular specials control 738, and change location control 740.

A consumer that has previously registered with the consumer interface module 242 can use login controls 722 to login to the consumer interface module 242, in some embodiments. The login controls 722 receive a username and password from the consumer, for example, which are compared to usernames and passwords stored in consumer data 654 of data store 118 (FIG. 13). If a match is found, the consumer is permitted to login. If a match is not found, the consumer is prompted to retry, or can be prompted to complete a consumer registration process to register with the consumer interface module 242. However, in some embodiments consumers can also choose to utilize the consumer interface module without logging in if they prefer.

Once logged in, the consumer interface module 242 can store various information for the consumer, such as consumer preferences, locations, and favorites. In some embodiments the consumer interface module 242 includes a favorites display, and a consumer can add any business to the favorites display, such as by selecting an “add to favorites” link (not shown) that can be included on the business details display page (FIG. 20) or other displays of the consumer interface module.

If a consumer desires to register, the consumer interface module presents one or more displays that prompt the user to enter various consumer data. The data can include, for example, the consumer's name, address, telephone number, e-mail address, and to select a username and password. Additional information and preferences can be received in some embodiments. In addition, the user is provided with a privacy policy and/or terms of service agreement that clearly defines how personal data will and will not be used within the system. All consumer and business information within the system 100 is carefully protected and utilized only in accordance with the permitted uses clearly identified in the privacy policy.

In some embodiments, consumer location information is obtained during the consumer registration process. Examples of the consumer location information include the street address, state, zip code, region, or global positioning system (GPS) coordinate where the consumer's computing device 120 or 122 is located or typically used, such as the address of a home or business address. This information can be manually entered by the consumer, or can be automatically provided by the computing device 120 or 122. For example, in some embodiments computing device 120 or 122 include or are in data communication with a location device, such as a GPS device that provides location information, which is sent to the consumer interface module across the data communication network 115 (FIG. 1).

Location information can also or alternatively be obtained outside of the registration process. For example, in some embodiments the user is prompted by the consumer interface module 242 to enter a current location. As a more specific example, the main menu 720 includes, in some embodiments, a change location control 740 that can be selected by the user to initiate a location selection process. The location selection process prompts the user to enter a current location, or another desired location (e.g., a location that the consumer is planning to be at some time in the future).

In another possible embodiment, location information is automatically obtained by the consumer interface module 242 from the computing device 120 or 122, such as upon (or after) accessing the consumer interface module 242. In some embodiments, the location information is GPS data (such as including a GPS coordinate), received by a GPS device and delivered to the computing device 120 or 122. The GPS data is then transferred to the consumer interface module 242 from the computing device 120 or 122.

The location display 724 shows the current identified location for the consumer, which can be used by the consumer interface module to provide more relevant information to the consumer, by utilizing the location information as at least one criterion of a search, as discussed in more detail herein.

The main menu display 720 further includes a browse control. Upon selection of the browse control 726, the consumer interface module 242 generates a display that lists some of the businesses contained in the business data 650 of data store 118 (FIG. 13). In some embodiments, the consumer interface module 242 first displays results that are at or nearest to the location identified in display 724. The consumer can then browse through the listed businesses using navigation controls such as next and back buttons to view additional lists of businesses. A particular business can be selected from the list to cause the consumer interface module 242 to display more information about the business, such as shown in FIG. 20.

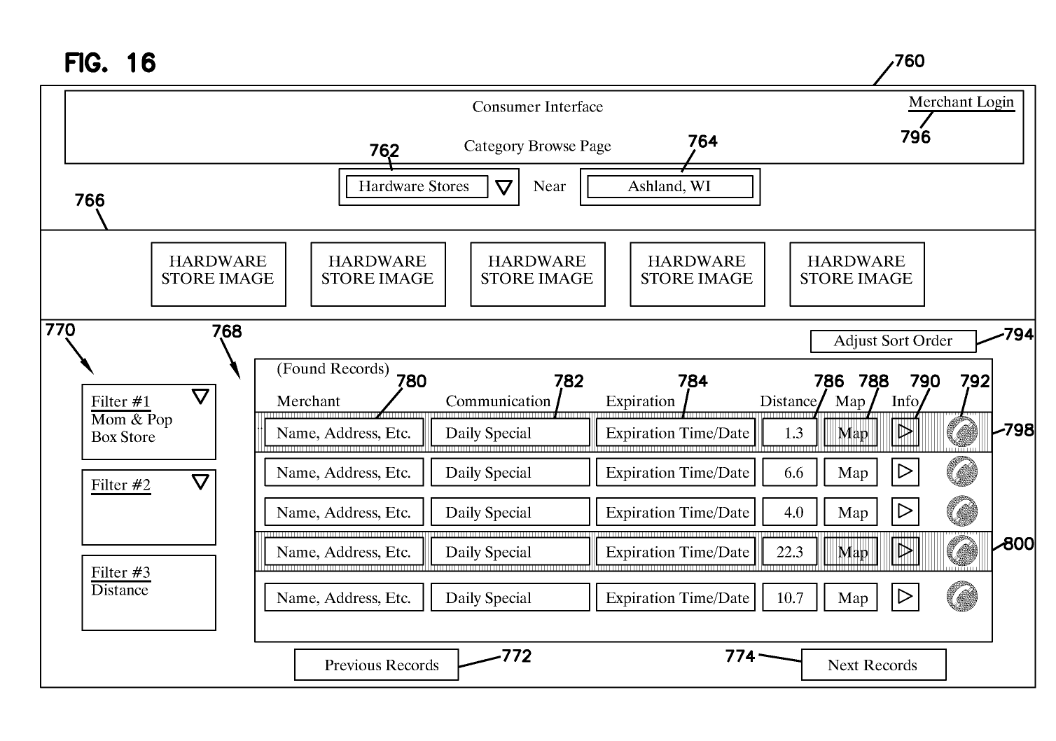

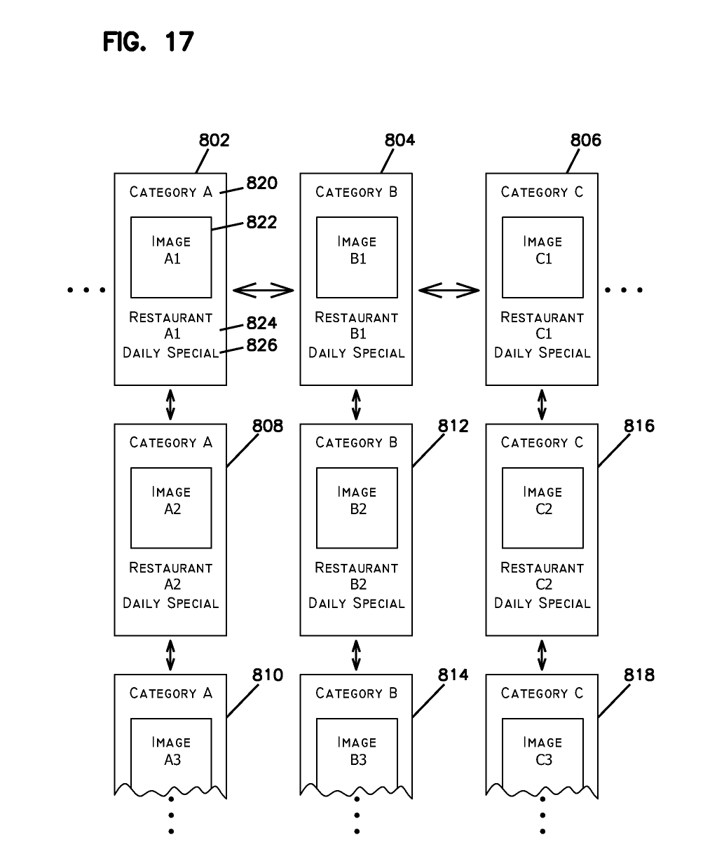

A browse by category control 728 is similar to the browse control 726, but can be selected to display lists of businesses within certain categories. Examples of categorical business listing displays are shown in FIGS. 16-17.

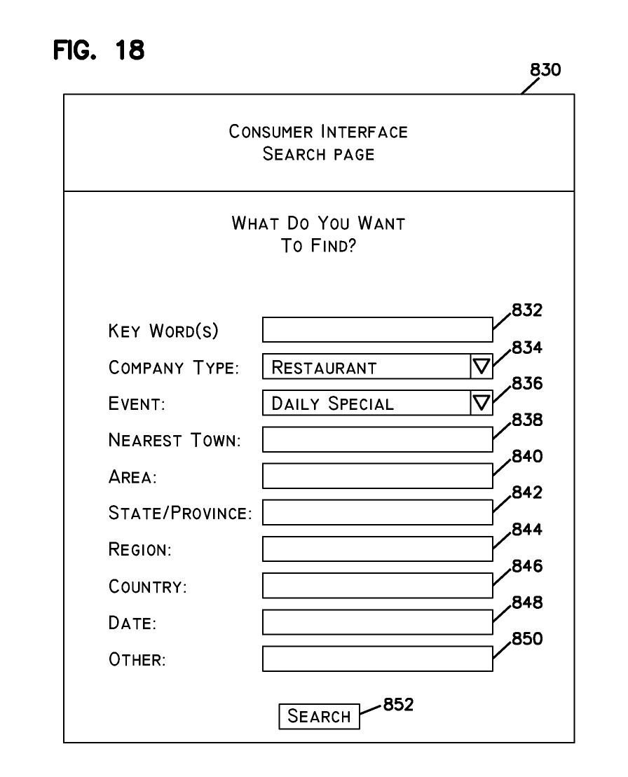

The search control 730 can be selected to initiate a business search process. In some embodiments, upon selection of the search control 730, the consumer interface module 242 displays the search page as illustrated and described with reference to FIG. 18.

Search nearby control 732 can be selected to initiate a business search process, which is specifically directed to nearby businesses. For example, in some embodiments search results are limited to a predefined or selectable range from the location identified by display 724. The range can be, for example, businesses within 2 miles, 5 miles, 10 miles, 25 miles, 50 miles, or 100 miles of the location. In another possible embodiment, the consumer interface module automatically identifies a suitable range, such as based on the number of businesses within the range. For example, if a location is within a downtown business district, the range is set to a relatively shorter distance due to the many businesses at that location, but if the location is in a rural area, the range is set to a relatively longer distance due to the reduced number of businesses at or around that location. In some embodiments, the search identifies a fixed (or selectable) number of search results, such as 10, 20, 50, 100, 200, 250, 500, etc, and the range is progressively expanded until the number of search results has been achieved or until no additional business records are available that satisfy the search query.

Restaurant lookup control 734 can be selected to search for a particular restaurant. For example, the consumer interface module 242 prompts the user to enter the name of the restaurant. A search is then performed for restaurants that have the same or most similar name to the name that is entered.

Featured specials control 736 can be selected to cause the consumer interface control 242 to display a set of featured special offers of businesses. A special offer can be featured for a variety of reasons, such as when a business has paid to have a special offer listed in the featured specials, or by selection of an editor or other representative of the service provider of the business promotion system (e.g., as an “Editor's Pick” or to highlight particularly good deals being offered by businesses). In some embodiments businesses can subscribe at an upgraded or premium subscription level (FIG. 6) and automatically have some or all of their special offers included as featured specials.

The popular specials control 738 can be selected to cause the consumer interface module to display a list of the most popular special offers, such as identifying those special offers that have been viewed the greatest number of times by consumers in a given period of time, or by identifying special offers that have been given the highest ratings or best feedback by consumers.

FIG. 16 is a screen shot of an example categorical business listing display 760, such as generated by the consumer interface module 242. In this example, the display 760 includes category control 762, location control 764, graphical results display 766, business listing 768, filter controls 770, and navigation controls 772 and 774.

The categorical business listing display 760 prompts the consumer to select a category with category control 762. A category can be, for example, a company type, a restaurant style, a restaurant cuisine, or a variety of other possible categories. In this example, the category control 762 provides a drop down menu in which the consumer can select from a variety of company types.

Location control 764 displays the current location (such as shown in location display 724 of FIG. 15). If a different location is desired, the location control 764 is selected, and the consumer is then prompted to select a new location.

The consumer interface module 242 performs a search of business data to identify business that have the company type identified by control 762 (“Hardware Store”) and are also at or within a range of the location identified by control 764. To do so, a search module of the business promotion system performs a search of the data contained within data store 118, such as by searching through business data 650. Business records are evaluated to determine whether the business has a business type that matches the type selected in control 762, and whether the location of the business is at the location identified by control 764 or within a range of the location. A list of at least some of the identified businesses is then displayed in one or both of graphical results display 766 and business listing 768.

Graphical results display 766 displays the results in a graphical form. An image associated with each business is displayed, and can be selected by the consumer to be taken to the associated business details page. In some embodiments the graphical results display 766 includes navigation controls (not shown) to advance the display (e.g., next or back controls) to view additional businesses.

In another possible embodiment, graphical display 766 displays some of the available categories, such as available from the category control 762. In this example, the first graphical element depicts a business from a first category (e.g., hotels), another business from a second category (e.g., restaurant), the third graphical element depicts a business from the currently selected category (e.g., hardware), etc. In this way, various alternative businesses are displayed and can be selected by the consumer for more information or to switch to a different category. Another similar embodiment is depicted in FIG. 17.

Business listing 768 displays the businesses in a list or table form. In this example, the business listing display 768 includes a list of five businesses, although more or fewer businesses can be listed as desired. Information about each business is displayed, including an business identifier 780 (e.g., name, address, etc.), a communication 782 from the business (e.g., a special offer, advertisement, or other information provided through the business interface module), an end date display 784 showing when the information in the communication will end (e.g., the expiration of a special offer), a distance display 786 showing the distance from the current location to the business, a map control 788 to display directions to the business, a details control 790 to display more details about the business (e.g., FIG. 20), and a call control 792 to initiate a call to the business.

Often times the number of businesses that are in the location and within the selected business category will exceed the number of businesses that can be included in business listing display 768. Accordingly, a ranking algorithm can be used to select a subset of the matching businesses for display in the first business listing display 768. The ranking algorithm can consider a variety of factors, such as popularity of the business, location of the business, consumer preferences, historical data for the consumer, business name (e.g., to list results in alphabetical order), business subscription level, a magnitude of a special offer (e.g., the magnitude of the discount being offered, such as by percentage or cash savings amount), or a variety of other factors. Additional business listing displays are displayed upon selection of the previous or next navigation controls 772 and 774. Further, in some embodiments the order in which businesses are listed can be adjusted based on or based at least in part on an order identified by the consumer through sort order control 794.

In some embodiments, at least some of the information included in the business listing display is information that is directly available from the records in the data store 118, such as from the business records stored in business data 650, or from the specials records stored in specials data 652. Some of the information can also be computed based on information in the data store 118. For example, the distance 786 can be computed using the current location data for the consumer and the location data of the business from business data 650 of data store 118. A mapping module is utilized in some embodiments to compute or provide some of this data, such as the distance and map data. An example of a mapping module is Google Earth or Google Maps.

In some embodiments, the map control 788 initiates a transfer of data to a GPS device. The GPS device can be part of the computing device or external to the computing device. Examples of external GPS devices include a GPS device installed on or within a dash of an automobile or a handheld or portable GPS device. To initiate a transfer, the computing device (such as smart phone 122) transmits location data for a selected business to the GPS device. The transmission can occur through a wireless communication device, such as utilizing the BLUETOOTH or IEEE 802.11 wireless communication standards, for example. The location data can include the address of the business, or the GPS coordinates for the business. Upon receipt of the location data, the GPS device displays the location of the business on a map and determines the current location of the GPS device. Knowing this information, the GPS device computes and displays driving directions between the current location and the location of the business. This can all occur without further input from the consumer after selection of the map control 788.

In some embodiments, certain businesses can be more prominently displayed than other businesses within business listing display 768. For example, businesses 798 and 800 are visually distinguishable from other businesses. In some embodiments, the businesses 798 and 800 are featured businesses. The graphical display of these businesses is different from non-featured businesses, such as by using a different colored background, different fonts, colors, font characteristics, or other graphical elements to highlight the respective business.

In this example, the display 760 also includes a business login control 796, which a business representative can use to login to the business interface module 240, providing a link between the consumer interface module 242 and the business interface module 240.

FIG. 17 is schematic block diagram illustrating exemplary user interface displays of the consumer interface module 242. This example illustrates an example user interface, such as can be displayed on a smart phone computing device 122. In this example, the user interface includes business displays 802, 804, 806, 808, 810, 812, 814, 816, and 818.

In some embodiments, the consumer interface module 242 generates the user interface depicted in FIG. 17. For example, display 802 is first displayed to the consumer on the computing device 122. The display includes an identification of a category 820, an image display 822, a business name display 824 (Restaurant A1), and a communication display 808.

In this example, the category 820 (Category A) displays a type of restaurant cuisine. Examples of types of restaurant cuisines include American, French, German, Italian, Chinese, etc. Therefore, an example of Category A is American.

The consumer interface module performs a search to identify one of the businesses matching the category, and in some embodiments, one of the restaurants that is also in or within a range of the current location. Information about this first business is then displayed, such as by displaying an image (Image A1) from the business in image display 822, the name of the business (Restaurant A1) in business name display 824, and a communication (Daily Special) from the business in the communication display 808. A variety of other information can be displayed, as desired.

The computing device 122 then waits for an input from the consumer. In some embodiments, inputs are received through a touch sensitive display. As one example, if the consumer taps on the screen, more detailed information about the business or business communication may be provided. If the consumer slides a finger left or right on the screen, the consumer interface module 242 adjusts the selected category. Sliding to the right, for example, advances the display to display 804, while sliding to the left advances the display to display 806. If the consumer slides a finger up or down on the display, the consumer interface module 242 advances to the next business within the category. Sliding down, for example, advances the display to display 808, while sliding up advances the display to display 810.

In some embodiments, when the category is advanced, the first business in the next category is displayed. For example, when displays 808 or 810 are displayed, advancement to Category B will result in display 804 being displayed, rather than displays 812 or 814.

Once display 804 is shown, inputs can be received to view additional businesses in the category (e.g., displays 812 or 814) or to advance to a different category, such as back to Category A with display 802 or forward to Category C with display 806.

In another possible embodiment, navigation controls (not shown in FIG. 17) are displayed, such as including controls to advance to a different category, and controls to advance to a different business. A variety of other controls can also be used, such as drop down menus, etc.

In some embodiments, upon selection of a business (such as by clicking, tapping, or otherwise providing an input to select a business), subsequent action associated with the business is taken. In some embodiments the subsequent action includes displaying a more detailed business display, displaying a map, providing driving directions to the business, transferring a destination location to a GPS device, dialing the businesses telephone number, sending an electronic message or text message to the business or to another recipient, or a variety of other possible actions.

FIG. 18 is a screen shot of an example search display 830, such as generated by the consumer interface module 242. The search display 830 prompts the user to enter a search query. In some embodiments the query can include keywords and search scope limitations.

In this example, the search display includes a keyword field 832, and a plurality of search scope limitations, such as a company type field 834; event type field 836; location fields such as nearest town field 838, area field 840, state/province field 842, region field 844, and country field 846; date field 848; or a variety of other possible fields 850. The search control 852 can be selected to initiate a search, such as utilizing a search module of the consumer interface module 242, which performs the search across data stored in data store 118 (FIG. 13).

Keywords can be entered by the consumer into the keyword field 832. In some embodiments, the keyword field 832 permits free entry of alphanumeric characters (including symbols), which will be searched for identical matches. In another possible embodiment, similar matches can also be returned, such as to return likely matches when a keyword is misspelled. Boolean operators (and, or, not, etc.) are permitted in some embodiments.

Additional limitations can be included as part of the search query, if desired by the consumer. Examples of such search scope limitations are shown, but any other search scope limitation can also be used, provided that the data store 118 contains the appropriate data.

One example of a search scope limitation is a company type limitation, which can be selected from the company type field 834. In this example, the field 834 is a drop down menu that displays a list of available company types. If a search is performed that includes this limitation, the search module identifies businesses that have the selected company type in the business record. Businesses that do not have the selected company type are not included in the search results.

Another example of a search scope limitation is an event type limitation, which can be selected from the event type field 836. If an event type is selected, only those advertisements or businesses including the associated event type are included in the search results.

Another example of a search scope limitation is a location limitation, which can be selected with any one or more of the exemplary location fields 838, 840, 842, 844, or 846. In some embodiments the location limitation is automatically applied to a search, based upon the consumer's current location or upon a previously identified location, without requiring the user to specifically identify the location.

The location search scope limitation feature permits the business promotion system 102 to be efficiently used by businesses and consumers spanning a large distance, such as an entire state, country, continent, or even across the world, without requiring consumers to manually search through a large volume of businesses or special offers that are not of interest to them.

Another example of a search scope limitation is a date limitation. As one example, a date or range of dates can be entered into the date field 848. The date limitation can be used, for example, to exclude from search results any advertisement or communication that is not active (e.g., as identified by the period including and between the start date and the end date) on the date or at least one of the range of dates. As another example, the date limitation can be used to exclude businesses that do not have an advertisement that is active on the date or at least one of the range of dates.

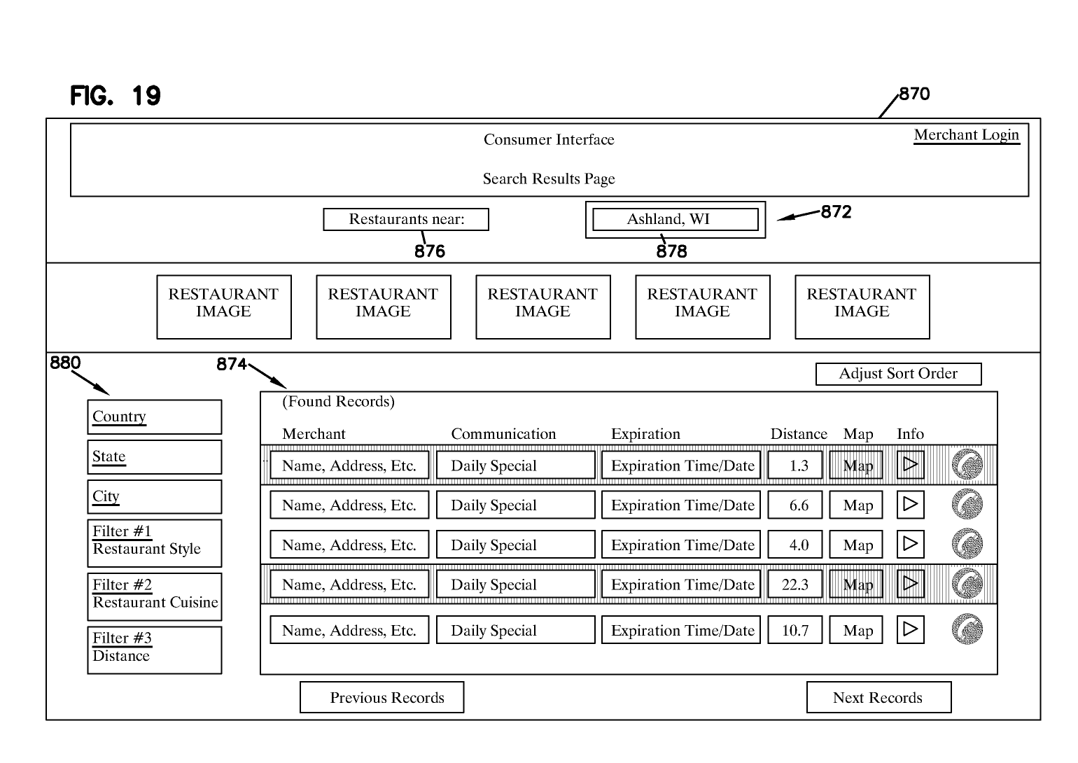

FIG. 19 is a screen shot of an example search results display 870, such as generated by consumer interface module 242. The search results display 870 includes a search query display 872 and business listing display 874.

Search results display 870 displays the search query for which the search has been conducted. In this example, the search query did not include any keywords, but included several search scope limitations, including a company type limitation 876 of restaurant, and a location limitation 878 of “near Ashland, Wis.”

The query was executed by the search module of the business promotion system, to identify businesses within the data store 118 that match, or are closest to, the search criteria.

Business listing display 874 displays the first set of search results, such as five businesses. More or fewer businesses can be listed, as desired.

This example display 870 includes additional controls similar to or the same as controls of the display 760 described herein with reference to FIG. 16, and such controls can be similarly used in display 870.

To further modify the search query, search scope limitation controls 880 are provided adjacent the business listing display 874 so that the consumer can make additional modifications to the search query and rerun the search without requiring the consumer to return to the search display (FIG. 18).

FIG. 20 is a screen shot of an example business details display 900, such as generated by the consumer interface module 242.

Business details display 900 includes information about a single business, and can function as a personal web site for the business, in some embodiments. The business details display 900 is generated automatically in some embodiments based on the data stored in the data store 118, and received from the business, such as during the new business registration process illustrated in FIG. 5. As a result, the business does not have to invest time and resources into generating a custom web site. Alternatively, the business details display 900 supplements other web sites that the business may have and can drive additional traffic to the business or web site.

In this example, business details display 900 includes business name 902, business address 904, telephone number 906, call control 908, web site link 910, social network link 912, brief description display 914, advertisement display 916, image display 918, video display 920, other controls 922, and audio control 924.

Much of the information included on business details display 900 is obtained during the new business registration process (although much of this information can be modified by the business representative at any time), and stored in business data 650 (FIG. 13). For example, with reference to FIG. 5, business name 902 is obtained from business name field 300, address 904 is obtained from physical address field 303 and city state zip field 305. Telephone number 906 is obtained from telephone field 307. The URL for web site link 910 is obtained from web site field 313. Social network link 912 is obtained from a social networking field (not shown). Brief description display 914 displays data obtained from brief description field 310. Image display 918 displays an image obtained from image field 315. Video display 920 displays a video obtained from a video field (not shown). Audio control 924 can be selected to play an audio file obtained from audio clip field 316.

In some embodiments, business details display 900 further includes advertisement display 916, which displays information received from a business representative through the advertisement generator, such as shown in FIG. 12, and stored in specials data 652 of data store 118 (shown in FIG. 13). In this example, advertisement display shows the daily special for today's date, which is: “¼ herb roasted chicken garlic scalloped potato and a fresh vegetable, all for only $6.00.”

Some embodiments include call control 908, which can be selected to cause the computing device or associated telephone to dial the telephone number 906, so that the consumer can contact a business representative, such as to make a reservation.

Other controls 922 can also be included, such as a distance display, map control, e-mail control, share with social network control, parking instructions control, request reservation control, and a variety of other possible controls. The map control can be selected to display a map and directions from a current location to the business, or alternatively to transfer location data to a GPS device, which provides this information.

In some embodiments, the business details display 900 further includes content received from other sources, such as from third party systems. For example, in some embodiments, consumer interface module 242 operates as a data aggregator to collect information from other systems and display that information on the business details display. Examples of third party systems include social networking sites (e.g., Facebook, MySpace, Twitter), group purchasing systems (e.g., Groupon, Living Social), or other sources.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of communicating restaurant special offers to consumers, the method comprising:
providing from a server computing device a web-based business interface to be displayed to business representatives associated with multiple restaurants;
receiving from the business representatives business information associated with the restaurants through the web-based business interface, the information including at least names of the restaurants and locations of the restaurants;
receiving from the business representatives information about nonredeemable special offers available from the restaurants, the information including at least a description of the special offer, a start date associated with the special offer, and an end date associated with the special offer;
storing the information associated with the restaurants as business data in a data store;
storing information about nonredeemable special offers available from the restaurants in specials data in a data store;
providing a web-based consumer interface to be displayed to a consumer;
receiving a search query from the consumer through the consumer interface, the search query including an identification of a category;
automatically identifying a location of the consumer;
determining a current date;
performing a search of the business data in the data store to identify search results including a set of restaurants that match the identified category, which are at the location, and which have at least one special offer in which the current date is between or equal to one of the start date and the end date; and
providing at least some of the search results to the consumer through the consumer interface, including at least one of the descriptions of the special offers.

2. The method of claim 1, wherein the information about special offers received from the business representatives is published to the consumer interface upon selection of a publish control of the business interface.

3. The method of claim 2, further comprising:
receiving a selection of one of the businesses; and
transmitting the location of the selected restaurant to a GPS device to permit the GPS device to display a map of the location and to provide directions to the restaurant to the consumer.

4. The method of claim 1, further comprising:
receiving a request to select a different category from the consumer, the request being initiated by a side-to-side movement detected by a touch sensitive display of a computing device; and
repeating the search using a different category.

5. The method of claim 1, wherein the business interface further provides business tools that assist businesses with non-advertising business operations.

6. The method of claim 5, wherein the business tools include a recipe library tool, training materials tool, and cleaning information tool.

7. The method of claim 6, wherein the cleaning information tool includes cleaning procedures and cleaning assignments, wherein the cleaning assignments include a list of cleaning tasks to be performed on a given date, and names of restaurant staff that are assigned to complete each task.

8. A system for promoting business specials, the system comprising programmable electronics including at least one processor and at least one computer readable storage medium, wherein the at least one computer readable storage medium contains instructions, which when executed by the at least one processor, cause the at least one processor to generate:
a business interface module that receives data describing special offers that are available for limited times from multiple different businesses;
a data store storing the data describing the special offers in the at least one computer readable storage medium, and further storing data for each of the multiple different businesses including at least names of the businesses and locations of the businesses;
a search module operable to perform a search of the data stored in the data store based on a search query and operable to identify a set of businesses that match the query; and
a consumer interface module configured to receive input from a consumer defining the search query to be searched by the search module and to convey at least some of the set of businesses identified by the search module for display to the consumer.

9. The system of claim 8, wherein the limited times are defined by a start date and an end date.

10. The system of claim 9, wherein the limited times are further defined by start times and end times.

11. The system of claim 8, wherein at least some of the businesses are restaurants, and wherein the business interface module further provides business tools to assist with non-advertising business operations, including recipe management, training materials management, and cleaning scheduling.

12. A method of promoting a business, the method comprising:
receiving at a computing device business information from business representatives of a plurality of businesses, the business information including at least names of the businesses and locations of the businesses;
receiving subscription fees from the businesses;
receiving with a computing device information to be communicated to consumers, the information originating from one of the business representatives of one of the businesses;
identifying a location of a consumer;
identifying a set of the businesses within a range of the consumer, the set of businesses including at least the one of the businesses; and
sending the information to be communicated to the consumer.

13. The method of claim 12, further comprising:
receiving a search query from the consumer;
and wherein identifying a set of the businesses further comprises identifying the set of the businesses that match the search query.

14. The method of claim 12, wherein sending the information comprises generating a consumer interface display including details about the at least one of the businesses and including the information.

15. The method of claim 14, wherein the information is a daily special of a restaurant.
